(19) United States
(12) Patent Application Publication
(10) Pub. No.: US 2007/0215837 A1
(43) Pub. Date: Sep. 20, 2007

(54) Highly crystalline nanoscale phosphor particles and composite materials incorporating the particles

(76) Inventors: Shivkumar Chiruvolu, San Jose, CA (US); Weidong Li, San Jose, CA (US); Igor Altman, Fremont, CA (US); Hui Du, Sunnyvale, CA (US); Nobuyuki Kambe, Menlo Park, CA (US); Ronald J. Mosso, Fremont, CA (US)

Correspondence Address: DARDI & ASSOCIATES, PLLC, 220 S. 6TH ST., SUITE 2000, U.S. BANK PLAZA, MINNEAPOLIS, MN, 55402, US

(21) Appl. No.: 11/717,604

(22) Filed: Mar. 13, 2007

Related U.S. Application Data
(60) Provisional application No. 60/782,828, filed on Mar. 16, 2006.

(51) Int. Cl. C09K 11/08

(52) U.S. Cl. 252/301.4 R; 252/301.4 P; 252/301.4 F; 252/301.4 S; 252/301.4 H; 252/301.5; 252/301.6 R; 252/301.6 S; 252/301.6 P; 252/301.6 F; 252/301.36

(57) ABSTRACT

Collections of phosphor particles have achieved improved performance based on improved material properties, such as crystallinity. Display devices can be formed with these improved submicron phosphor particles. Improved processing methods contribute to the improved phosphor particles, which can have high crystallinity and a high degree of particle size uniformity. Dispersions and composites can be effectively formed from the powders of the submicron particle collections.

### CROSS REFERENCE TO RELATED APPLICATIONS

This application claims the benefit of copending provisional U.S. patent application 60/782,828 to Chiruvolu et al. filed on Mar. 16, 2006 entitled “Highly Crystalline Nanoscale Phosphor Particles And Composite Materials Incorporating The Particles;” only with regard to the disclosure which is disclosed in the instant application. This application disclaims the benefit of the above U.S. Provisional Application with regard to the disclosure which is not disclosed in the instant application.

### FIELD OF THE INVENTION

The invention relates to phosphor nanoparticles that emit light following excitation. More particularly, the invention relates to nanoscale phosphor particles with a high degree of crystallinity. These phosphor particles can be incorporated into composites, which are highly desirable for various applications.

### BACKGROUND OF THE INVENTION

Electronic displays often use phosphor materials, which emit visible light in response to interaction with electrons, a field and/or to light, such as visible or ultraviolet light. Phosphor materials can be applied to substrates to produce cathode ray tubes, flat panel displays, field emission devices and the like. Improvements in display devices place stringent demands on the phosphor materials, for example, due to decreases in electron velocity or excitation energy and hence lower power consumption and increases in display resolution, for higher definition of images, for a higher saturation of colors, and/or for stability of color and brightness over a longer life time. Electron velocity is reduced in order to reduce power demands. In particular, flat panel displays generally require phosphors that are responsive to low velocity electrons or low voltages.

In addition, a desire for color display requires the use of materials or combinations of materials that emit light at different wavelengths at positions in the display that can be selectively excited. A variety of materials have been used as phosphors. In order to obtain materials that emit at desired wavelengths of light, activators have been doped into phosphor material. Alternatively, multiple phosphors can be mixed to obtain the desired emission. Furthermore, the phosphor materials should show sufficient luminescence.

In addition, technological advances have increased the demand for improved material processing with strict tolerances on processing parameters. As miniaturization continues even further, material parameters will need to fall within stricter tolerances. Current integrated circuit technology already requires tolerances on processing dimensions on a nanometer scale.

Various metal compositions exhibit desired emission properties upon excitation. Specifically, various metal oxides, including rare earth metal oxides exhibit fluorescence/phosphorescence. In addition, doping of rare earth metals into non-rare earth metal oxides or other host materials can be used to adjust the wavelength and luminosity of the phosphor particles.

### SUMMARY OF THE INVENTION

In a first aspect, the invention pertains to a collection of particles comprising a crystalline phosphor composition, the collection of particles having a number average primary particle size of no more than about 100 nm, a weight average secondary particle size of no more than about 250 nm and an crystallinity of at least about 90%.

In a further aspect, the invention pertains to a method for the production of particles in a flowing reactor. The method comprises reacting a reactant flow to generate product particles within the flow in which the reactant flow comprises a heated aerosol. The heated aerosol is heated to a temperature at least about 10° C. greater than ambient temperature. In some embodiments, the reaction is driven by a light beam that intersects the reactant flow, which comprises compositions that absorb light from the beam. In some embodiments, the product particles have an average particle size of no more than about 500 nm, and the particles can have high particle size uniformity while being formed at a high production rate.

Moreover, the invention pertains to a method for processing a collection of inorganic phosphor particles having an average particle size no more than about 250 nm. The method comprises heating the particle collection at a first temperature from about 250° C. to about 600° C. for 5 minutes to about five hours in an oxidizing atmosphere and heating the particle collection in a reducing atmosphere for about 5 minutes to about 48 hours at a second temperature above the first temperature. The second temperature is sufficient to anneal the crystal structure of the particles while being at least above the transformation onset temperature of a desired phase and at least 100° C. below the melting temperature of the particles. In some embodiments, the method further comprises heating the particle collection at a third temperature below the second temperature and above the first temperature for five hours to 24 hours in a reducing atmosphere without causing significant sintering of the particles while increasing the crystallinity of the particles as determined by x-ray scattering.

### BRIEF DESCRIPTION OF THE DRAWINGS

FIG. 1 is a schematic, sectional view of an embodiment of a laser pyrolysis apparatus, where the cross section is taken through the middle of a radiation path. The upper insert is a bottom view of a collection nozzle, and the lower insert is a top view of an injection nozzle.

FIG. 2 is a schematic, side view of an embodiment of a reactant delivery apparatus for the delivery of vapor reactants to the laser pyrolysis apparatus of FIG. 1.

FIG. 3A is a schematic, sectional view of an alternative embodiment of the reactant delivery apparatus for the delivery of an aerosol reactant to the laser pyrolysis apparatus of FIG. 1, the cross section being taken through the center of the apparatus.

FIG. 3B is a schematic, sectional view of a reactant delivery apparatus with two aerosol generators within a single reactant inlet nozzle.

FIG. 4 is a schematic sectional view of an inlet nozzle of a reactant delivery system for the delivery of both vapor and aerosol reactants in which the vapor and aerosol reactants combine within the nozzle.

FIG. 5 is a perspective view of an alternative embodiment of a laser pyrolysis apparatus.

FIG. 6 is a sectional view of an inlet nozzle of the alternative laser pyrolysis apparatus of FIG. 4, the cross section being taken along the length of the nozzle through its center.

FIG. 7 is a sectional view of an inlet nozzle of the alternative laser pyrolysis apparatus of FIG. 4, the cross section being taken along the width of the nozzle through its center.

FIG. 8 is a perspective view of an embodiment of an elongated reaction chamber for performing laser pyrolysis.

FIG. 9 is a perspective view of an embodiment of an elongated reaction chamber for performing laser pyrolysis.

FIG. 10 is a cut away, side view of the reaction chamber of FIG. 9.

FIG. 11 is a partially sectional, side view of the reaction chamber of FIG. 10, taken along line 11-11 of FIG. 9.

FIG. 12 is a fragmentary, perspective view of an embodiment of a reactant nozzle for use with the chamber of FIG. 9.

FIG. 13 is a schematic, sectional view of an apparatus for heat treating nanoparticles, in which the section is taken through the center of the apparatus.

FIG. 14 is a schematic, sectional view of an oven for heating nanoparticles, in which the section is taken through the center of a tube.

FIG. 15 is a sectional view of an embodiment of display device incorporating a phosphor layer.

FIG. 16 is a sectional view of an embodiment of a liquid crystal display incorporating a phosphor for illumination.

FIG. 17 is a sectional view of an electroluminescent display.

FIG. 18 is a sectional view of an embodiment of a flat panel display incorporating field emission display devices.

FIG. 19 is a sectional view of elements of a plasma display panel.

FIG. 20 is an x-ray diffractogram of a representative as-synthesized sample of YAlO₃ perovskite phase from laser pyrolysis.

FIG. 21 is a scanning electron micrograph of an as-synthesized sample with YAlO₃ perovskite phase from laser pyrolysis.

FIG. 22 is an x-ray diffractogram of a representative sample of Y₃Al₅O₁₂:Ce garnet (YAG) after a three step heat treatment.

FIG. 23 is an x-ray diffractogram of a representative sample of Y₃Al₅O₁₂:Ce garnet (YAG) after a three step heat treatment.

### DETAILED DESCRIPTION OF THE INVENTION

Highly crystalline and uniform submicron and nanoscale phosphor particles exhibit highly desirable optical properties. In addition, the small size of the particles provides for the formation of smaller and/or thinner structures with corresponding higher resolution at the boundaries of components within the structure. Also, the small phosphor particles provide for energy savings for embodiments based on electron excitation of the particles through the need for lower energy excitation to excite the submicron phosphor particles. The submicron/nanoscale phosphor particles can be produced with laser pyrolysis, generally with additional processing to introduce desired properties. Due to the small size of the phosphor particles, the particles can be more transparent to visible light when compared with larger phosphor particles. For the formation of optical structures or other functional structures, the submicron phosphor particles can be incorporated into polymer-inorganic particle composites, which can then be molded or otherwise processed into desirable structures. The polymer can function as a binder within the composite. The phosphor particles can be effectively combined with a surface modifying agent to facilitate their incorporation into a polymer composite or their processing into various device structures. Various displays and other optical or electro-optical devices can be formed from the phosphor particles and/or composites described herein.

The particles of interest exhibit luminescence through fluorescence or phosphorescence following excitation with fields, electrons or energetic light. Many compositions of interest are metal compounds with suitable dopants. Suitable control of crystallinity, particle size, dopant levels, dopant oxidation state and lattice structure are significant for obtaining high luminosities. At the same time, in some embodiments, small average particle sizes no more than about 100 nm results in significantly reduced scattering of visible light, which complements the advantages of high luminosity. Furthermore, high uniformity of the particles with respect to particle size, crystallinity and doping results in improved optical properties through the reduction of inhomogenous behavior.

Inorganic particles generally include metal and/or metalloid elements in their elemental form or in compounds. Specifically, inorganic particles can include, for example, elemental metal or elemental metalloid, i.e. un-ionized elements, alloys thereof, metal/metalloid oxides, metal/metalloid nitrides, metal/metalloid carbides, metal/metalloid sulfides, metal/metalloid silicates, metal/metalloid phosphates or combinations thereof. Phosphor particles can be doped or undoped metal/metalloid compositions. Metalloids are elements that exhibit chemical properties intermediate between or inclusive of metals and nonmetals. Metalloid elements include silicon, boron, arsenic, antimony, and tellurium. When the terms metal or metalloid are used without qualification, these terms refer to a metal or metalloid element in any oxidation state and in elemental form or in a composition. When a metal or metalloid composition is recited, this refers to any composition with one or more metal metalloid elements in oxidized, i.e., non-elemental, form with corresponding elements to provide electrical neutrality.

Surface modifiers can be used to improve the dispersability of the inorganic particles. Improving the dispersability can be effective for forming more uniform composites as well as generally improving the processability into various devices and the reduction or elimination of surface defects. Suitable surface modifiers may or may not covalently bond with the inorganic particle surface. If no bonding takes place, the surface modifier may be a surface active agent or the like.

With respect to composites, well dispersed inorganic particles can be incorporated into polymer-inorganic particle composites at high loading levels. With good dispersion, agglomerating within the composite is reduced or eliminated such that improved optical properties results for the composite. In general, loading of inorganic particles within the composite can be as high as 50 weight percent or even higher with well dispersed particles, although for certain applications lower particle loadings may be desirable. In general, the inorganic particles can be incorporated into a selected composite at a range of loadings appropriate for the particular application. The inorganic particles may or may not be bonded to the polymer. A linker compound can be involved in the bonding of the inorganic particles with the polymer. In addition, in embodiments involving chemically bonded composites, the amount of the linker compounds bonded to the inorganic particles can be adjusted to vary the degree of cross-linking obtained with the polymer.

Submicron metal composition particles with various stoichiometries and crystal structures can be produced by pyrolysis, especially laser pyrolysis, alone or with additional processing. In particular, approaches have been developed for the synthesis of multiple metal/metalloid oxide composite particles as well as other complex metal/metalloid composition particles. The plurality of metals/metalloid elements is introduced into the reactant stream. By appropriately selecting the composition in the reactant stream and the processing conditions, submicron particles incorporating the desired metal/metalloid composition stoichiometry optionally with selected dopants can be formed.

Desirable collections of metal/metalloid composition, for example metal/metalloid oxide, particles can have an average diameter no more than a micron and high uniformity with a narrow distribution of particle diameters. To generate desired submicron metal/metalloid composition particles, laser pyrolysis can be used either alone or in combination with additional processing, such as heat processing. Specifically, laser pyrolysis has been found to be an excellent process for efficiently producing submicron (less than about 1 micron average diameter) and nanoscale (less than about 100 nm average diameter) metal/metalloid oxide particles and other metal/metalloid composition particles with a narrow distribution of average particle diameters. In addition, submicron inorganic particles produced by laser pyrolysis can be subjected to heating under mild conditions in an appropriate environment to alter the crystal properties, oxidation state and/or the stoichiometry of the particles. Thus, a large variety of different types of inorganic particles can be produced using these approaches.

A basic feature of successful application of laser pyrolysis for the production of inorganic particles is production of a reactant stream containing one or more appropriate metal/metalloid precursors. A source of anion element(s) should also be provided. For example with respect to metal/metalloid oxides, the oxygen element can be bonded within the metal/metalloid precursors and/or can be supplied by a separate oxygen source, such as molecular oxygen. Similarly, unless the metal precursors and/or the oxygen source are an appropriate radiation absorber, an additional radiation absorber can be added to the reactant stream.

In laser pyrolysis, the reactant stream is pyrolyzed by an intense light beam, such as a laser beam. While a laser beam is a convenient energy source, other intense light sources can be used in laser pyrolysis. Laser pyrolysis provides for formation of phases of materials that are difficult to form under thermodynamic equilibrium conditions. As the reactant stream leaves the light beam, the metal/metalloid oxide particles are rapidly quenched.

Product materials of interest include amorphous materials, crystalline materials and combinations thereof. Amorphous materials possess short-range order that can be very similar to that found in crystalline materials. In crystalline materials, the short-range order comprises the building blocks of the long-range order that distinguishes crystalline and amorphous materials. In other words, translational symmetry of the short-range order building blocks found in amorphous materials creates long-range order that defines a crystalline lattice. For example, silica glass is an amorphous material comprised of (SiO₄)⁴⁻ tetrahedra that are bonded together at irregular bond angles. The regularity of the tetrahedra provides short-range order but the irregularity of the bond angles prevents long-range order. In contrast, quartz is a crystalline silica material comprised of the same (SiO₄)⁴⁻ tetrahedra that are bonded together at regular bond angles to form long-range order which results in a crystalline lattice. In general, the crystalline form is a lower energy state than the analogous amorphous form. This provides a driving force towards formation of long-range order. In other words, given sufficient atomic mobility and time, long-range order can form.

In laser pyrolysis, a wide range of inorganic materials can be formed in the reactive process. Based on kinetic principles, higher quench rates favor amorphous particle formation while slower quench rates favor crystalline particle formation as there is time for long-range order to develop. Faster quenches can be accomplished with a faster reactant stream velocity through the reaction zone. In addition, some precursors may favor the production of amorphous particles while other precursors favor the production of crystalline particles of similar or equivalent stoichiometry. Low laser power can also favor formation of amorphous particles. The formation of amorphous oxides is described further in U.S. Pat. No. 6,106,798 to Kambe et al., entitled “Vanadium Oxide Nanoparticles,” incorporated herein by reference. However, crystalline materials are of particular interest for phosphor applications, and the phosphor particles specifically described herein are highly crystalline.

Traditionally, phosphors are synthesized by solid state reactions between raw materials at high temperatures. In general, phosphors involve a host crystal with an activator. The activator is used to increase luminosity and alter the luminescent color of the phosphors. The activators generally take the form of a dopant that is introduced into the host crystal at low mole fractions. Other materials, called flux, can be added to facilitate the solid state reaction and to form well crystallized particles. Fluxes that have been used include, for example, alkali halides, such as KF, and alkali earth halides, such as MgF₂, and other non-transition metal halides, such as AlF₃. The laser pyrolysis approach with an optional subsequent heat treatment does not require a flux.

Phosphors generally comprise a host crystal or matrix and a small amount of activator as a dopant. Generally, heavy metal ions or rare earth ions are used as activators. In some phosphors, co-activators are also added for charge compensation. For example, with zinc sulfide host crystals, group IIIa ions (e.g., Al⁺³) or group VIIb ions (e.g., Mn) are used as co-activators. Co-activator ions help to form the luminescent center, while the luminescent spectrum is almost independent of the composition of the co-activator. Energy transfer processes are often used in commercial phosphors to enhance emission efficiency. The process is called sensitization of luminescence, and the energy donor is called a sensitizer. For example, the emission intensity of Mn⁺² activated sulfide phosphors are sensitized by Pb⁺², Sb⁺³ and Ce⁺³.

After the production of the particles by laser pyrolysis, generally it is desirable to heat treat the particles. Qualities of the inorganic particles can be altered by heat treating the initially synthesized particles. For example, the crystallinity and/or the phase purity of the particles can be altered by heat treatment. The heat treatment can be performed in an oxidizing atmosphere, a reducing atmosphere or an inert atmosphere to produce the desired resulting particles. Under suitably mild heating conditions, the particles do not sinter or otherwise fuse to an inappropriate degree.

The particles collected from the laser pyrolysis apparatus can be subjected to further processing to improve the phosphor characteristics. In particular, heat treatment can be used to further increase the crystallinity of the as synthesized particles. The heat treatment step can also be used to shift the oxidation state of a dopant to ensure that the dopant is in a functional oxidation state. The crystallinity and dopant are significant for obtaining high luminosity of the resulting phosphor particles. Particles as synthesized by laser pyrolysis are particularly amenable to heat treatment to obtain very high crystallinity.

The dopant level can directly relate to the luminescent properties of the particles. In general, additional dopant results in greater luminescence since the dopant forms absorption-emission centers within the particles. In general, the luminescence increases with dopant level as more electrons are available for promotion into emitting states. However, luminosity generally reaches a peak as a function of dopant concentration due to a balance of factors. In particular, luminescent properties depend on the crystallinity of the particle, the positioning of the dopant within the crystal lattice and the concentration. As the dopant level increases, quenching mechanisms come into play that decrease the luminescence, and there is an increase in crystal defects. Thus, at high enough dopant concentrations, the luminosity decreases with increasing dopant levels since the quenching begins to dominate over the increase from higher absorption. The quenching though is a function of the dopant incorporation into the crystal lattice, which is a function of the process to form the particles. With laser pyrolysis and subsequent heat treatment, very high levels of crystallinity can be achieved. Improvements in the laser pyrolysis process, such as heating the aerosol prior to delivery into the reaction chamber, results in the ability to incorporate a greater amount of dopant without increasing the quenching.

Co-doping can provide a range of effects. As noted above, co-dopants can function as co-activators or sensitizers. However, a co-dopant can also function to alter the properties of the activator within the crystal, for example, by changing local crystal symmetry around the activator, which in turn changes the potential energy levels of the activator in the crystal. Thus, co-dopants can have a synergistic effect in some circumstances. Below, effects of co-dopants in Cerium-doped YAG crystals is described further.

With highly crystalline inorganic phosphor particles, for example as synthesized by laser pyrolysis and optionally subjected to additional heat treatment, the resulting phosphor particles can have high luminosity. The average size of the particles, the dopant concentration and the dopant composition can influence the absorption spectrum and the emission spectrum.

To form a dispersion, the highly crystalline particles can be milled to facilitate the separation of the particles. Similarly, the particles, with or without prior milling, can be mixed vigorously to form the dispersion. The delivery of a surface modifying agent can further enhance the separation of the particles in the fluid.

In general, it is desirable to disperse the phosphor particles prior to formation of a polymer composite. For example, well dispersed particles generally exhibit higher output for a particular excitation. The dispersed phosphor particles can be blended with a polymer solution or a polymer melt, although in other embodiments, the polymer can be polymerized in the presence of the inorganic particles. The composite can be processed using, for example, conventional polymer processing techniques.

A variety of display applications can effectively incorporate the submicron particle phosphor particles. Composites with the submicron particles can be used to form smaller structures within the displays. For photo-luminescence application, the particles are formed into structures in which they receive light from a certain light source and they shift the emission to a higher wavelength. For cathodoluminescence and electroluminescence, the excitation is performed with an electromagnetic field or with electrons, respectively. The higher luminescent properties of the inorganic phosphor particles described herein provide for more efficient operation of devices generally based on any luminescence principle.

The small particle size and relatively high luminosity provide the ability for improved device formation and more efficient operation. High luminescence provides for the use of lower amounts of phosphors for a cost savings in materials. The scattering of the material can be reduced through better dispersion of the particles and greater size uniformity at a small average particle size. If the material has low scattering, light output of a device is higher relative to devices formed with materials without these improved properties, and the particles can be placed in the material at lower loadings since the total amount of phosphor particles can be less. In turn, the materials with lower loading of phosphor particles can be easier to process and correspondingly can have less scattering for a particular amount of processing effort.

### Particle Synthesis within a Reactant Flow

Laser pyrolysis has been demonstrated to be a valuable tool for the production of submicron/nanoscale particles, such as phosphor particles, with a wide range of particle compositions and structures alone or with additional processing. The reactant delivery approaches described in detail below can be adapted for producing particles with selected compositions in flowing reactant systems. Laser pyrolysis is a particularly appropriate approach in some applications for producing a doped particles and/or complex particle compositions because laser pyrolysis can produce highly uniform product particles at high production/deposition rates.

The production methods can be based on a flowing reaction system in which flowing reactants are reacted and product particles are formed within the flow. In particular, laser pyrolysis is a flowing reaction system in which the reaction of the flowing reactant stream is driven by an intense light beam that intersects with the flowing reactant stream. Flowing reactant systems generally comprise a reactant delivery apparatus that directs a flow through a reaction chamber. The reaction of the reactant flow takes place in the reaction chamber. The use of a radiation, e.g., light, beam, to drive the reaction can result in a localized reaction zone that leads to high uniformity of the particles. Beyond the reaction zone, the flow comprises product particles, un-reacted reactants, reaction by-products and inert gases. The flow can continue to a collector at which at least a portion of the product particles are harvested from the flow. Continuous supply of reactants to the flow and removal of product particles from the flow during the course of the reaction characterizes the reaction process within the flowing reactant system. Thus, flow refers to its conventional meaning of a net movement of material as in a stream from one point to another.

Laser pyrolysis has become the standard terminology for flowing chemical reactions driven by an intense radiation, e.g., light, with rapid quenching of product after leaving a narrow reaction region defined by the radiation. The name, however, is a misnomer in the sense that radiation from non-laser sources, such as a strong, incoherent light or other radiation beam, can replace the laser. Also, the reaction is not a pyrolysis in the sense of a thermal pyrolysis. The laser pyrolysis reaction is not solely thermally driven by the exothermic combustion of the reactants. In fact, in some embodiments, laser pyrolysis reactions can be conducted under conditions where no visible light emissions are observed from the reaction, in stark contrast with pyrolytic flames. Thus, as used herein, laser pyrolysis refers generally to a radiation-driven flowing reaction.

The reaction conditions can determine the qualities of the particles produced by laser pyrolysis. The reaction conditions for laser pyrolysis can be controlled relatively precisely in order to produce particles with desired properties. For example, the reaction chamber pressure, flow rates, composition and concentration of reactants, radiation intensity, radiation energy/wavelength, type and concentration of inert diluent gas or gases in the reaction stream, temperature of the reactant flow can affect the composition and other properties of the product particles, for example, by altering the time of flight of the reactants/products in the reaction zone and the quench rate. Thus, in a particular embodiment, one or more of the specific reaction conditions can be controlled. The appropriate reaction conditions to produce a certain type of particles generally depend on the design of the particular apparatus. Specific conditions used to produce selected particles in particular apparatuses are described below in the Examples. Furthermore, some general observations on the relationship between reaction conditions and the resulting particles can be made.

Increasing the light power results in increased reaction temperatures in the reaction region as well as a faster quenching rate. A rapid quenching rate tends to favor production of higher energy phases, which may not be obtained with processes near thermal equilibrium. Similarly, increasing the chamber pressure also tends to favor the production of higher energy phases. Also, increasing the concentration of the reactant serving as the oxygen source or other secondary reactant source in the reactant stream favors the production of particles with increased amounts of oxygen or other secondary reactant.

Reactant velocity of the reactant gas stream is inversely related to particle size so that increasing the reactant velocity tends to result in smaller particle sizes. A significant factor in determining particle size is the concentration of product composition condensing into product particles. Reducing the concentration of condensing product compositions generally reduces the particle size. The concentration of condensing product can be controlled by dilution with non-condensing, e.g., inert, compositions or by changing the pressure with a fixed ratio of condensing product to non-condensing compositions, with a reduction in pressure generally leading to reduced concentration and a corresponding reduction in particle size and vice versa, or by combinations thereof, or by any other suitable means.

Light power also influences particle size with increased light power favoring larger particle formation for lower melting temperature materials and smaller particle formation for higher melting temperature materials. Also, the growth dynamics of the particles have a significant influence on the size of the resulting particles. In other words, different forms of a product composition have a tendency to form different size particles from other phases under relatively similar conditions. Similarly, under conditions at which populations of particles with different compositions are formed, each population of particles generally can have its own characteristic distribution of particle sizes.

To form a desired composition in the reaction process, one or more precursors supply the one or more metal/metalloid elements that form the desired composition. The reactant stream generally would include the desired metal and, additionally or alternatively, metalloid elements to form the host material and, optionally, dopant(s)/additive(s) in appropriate proportions to produce product particles with a desired composition. The composition of the reactant stream can be adjusted along with the reaction condition(s) to generate desired product particles with respect to composition and structure. Based on the particular reactants and reaction conditions, the product particles may not have the same proportions of metal/metalloid elements as the reactant stream since the elements may have different efficiencies of incorporation into the particles, i.e., yields with respect to unreacted materials. The designs of the reactant nozzles for radiation driven reactions described herein are designed for high yields with high reactant flows. Furthermore, additional appropriate precursor(s) can supply any desired dopant/additive element(s).

Laser pyrolysis has been performed with gas/vapor phase reactants. Many precursor compositions, such as metal/metalloid precursor compositions, can be delivered into the reaction chamber as a gas/vapor. Appropriate precursor compositions for gaseous delivery generally include compositions with reasonable vapor pressures, i.e., vapor pressures sufficient to get desired amounts of precursor gas/vapor into the reactant stream. The vessel holding liquid or solid precursor compositions can be heated (cooled) to increase (decrease) the vapor pressure of the precursor, if desired. Solid precursors generally are heated to produce a sufficient vapor pressure. A carrier gas can be bubbled through a liquid precursor to facilitate delivery of a desired amount of precursor vapor. Similarly, a carrier gas can be passed over the solid precursor to facilitate delivery of the precursor vapor. Alternatively or additionally, a liquid precursor can be directed to a flash evaporator to supply a composition at a selected vapor pressure.

The use of exclusively gas phase reactants can be challenging with respect to the types of precursor compositions that can be used conveniently. Thus, techniques have been developed to introduce aerosols containing precursors, such as metal/metalloid precursors, into laser pyrolysis chambers. Improved aerosol delivery apparatuses for flowing reaction systems are described further in U.S. Pat. No. 6,193,936 to Gardner et al., entitled “Reactant Delivery Apparatuses,” incorporated herein by reference.

Using aerosol delivery apparatuses, solid precursor compositions can be delivered by dissolving the compositions in a solvent. Alternatively, powdered precursor compositions can be dispersed in a liquid/solvent for aerosol delivery. Liquid precursor compositions can be delivered as an aerosol from a neat liquid, a multiple liquid dispersion or a liquid solution. Aerosol reactants can be used to obtain a significant reactant throughput. A solvent/dispersant can be selected to achieve desired properties of the resulting solution/dispersion. Suitable solvents/dispersants include water, methanol, ethanol, isopropyl alcohol, other organic solvents and mixtures thereof. The solvent should have a desired level of purity such that the resulting particles have a desired purity level. Some solvents, such as isopropyl alcohol, are significant absorbers of infrared light from a CO₂ laser such that no additional light absorbing composition may be needed within the reactant stream if a CO₂ laser is used as a light source.

If precursors are delivered as an aerosol with a solvent present, the solvent generally can be rapidly evaporated by the radiation (e.g., light) beam in the reaction chamber such that a gas phase reaction can take place. The resulting particles are not generally highly porous, in contrast to other approaches based on aerosols in which the solvent cannot be driven off rapidly. Thus, the fundamental features of the laser pyrolysis reaction can be unchanged by the presence of an aerosol. Nevertheless, the reaction conditions are affected by the presence of the aerosol. Below in the Examples, conditions are described for the production of submicron/nanoscale particles using aerosol precursors in laser pyrolysis reaction chambers. Thus, the parameters associated with aerosol reactant delivery can be explored further based on the description below.

The precursor compositions for aerosol delivery are dissolved in a solution generally with a concentration in the range(s) greater than about 0.1 molar. Generally, increasing the concentration of precursor in the solution increases the throughput of reactant through the reaction chamber. As the concentration increases, however, the solution can become more viscous such that the aerosol may have droplets with larger sizes than desired. Thus, selection of solution concentration can involve a balance of factors in the selection of a suitable solution concentration.

In some embodiments, it has been found to be advantageous to heat the liquid for the formation of the aerosol prior to or during aerosol formation such that the aerosol droplets are introduced into the reaction zone at a higher temperature. Specifically, it has been surprisingly found that this heating facilitates formation of particle stoichiometry, especially dopant levels, that are difficult or impossible to form if the precursors are introduced at room temperature. In general, the liquid can be heated to a temperature just below the boiling point of the liquid at the pressures within the reaction chamber. Furthermore, the heating of the liquid has also been found to improve the uniformity of the resulting particles. Specifically, the heating of the liquid results in particle properties that more closely resemble the particle properties observed under a purely vapor phase reaction.

For embodiments involving a plurality of metal/metalloid elements, the metal/metalloid elements can be delivered all as vapor, all as aerosol or as any combination thereof. If a plurality of metal/metalloid elements is delivered as an aerosol, the precursors can be dissolved/dispersed within a single solvent/dispersant for delivery into the reactant flow as a single aerosol. Alternatively, the plurality of metal/metalloid elements can be delivered within a plurality of solutions/dispersions that are separately formed into an aerosol. The generation of a plurality of aerosols can be helpful if convenient precursors are not readily soluble/dispersible in a common solvent/dispersant. The plurality of aerosols can be introduced into a common gas flow for delivery into the reaction chamber through a common nozzle. Alternatively, a plurality of reactant inlets can be used for the separate delivery of aerosol and/or vapor reactants into the reaction chamber such that the reactants mix within the reaction chamber prior to entry into the reaction zone. Exemplary reactant delivery apparatuses are described further below.

In addition, for the production of highly pure materials, it may be desirable to use a combination of vapor and aerosol reactants. Vapor/gas reactants generally can be supplied at higher purity than is generally available at reasonable cost for aerosol delivered compositions. This can be particular convenient for the formation of doped optical glasses. For example, very pure silicon can be delivered in an easily vaporizable form, such as silicon tetrachloride. At the same time, some elements, especially rare earth dopant(s)/additive(s), cannot be conveniently delivered in vapor form. Thus, in some embodiments, a majority of the material for the product compositions can be delivered in vapor/gas form while other elements are delivered in the form of an aerosol. The vapor and aerosol can be combined for reaction, among other ways, following delivery through a single reactant inlet or a plurality of inlets.

The particles, in some embodiments, further comprise one or more non-(metal/metalloid) elements. For example, several compositions of interest are oxides. Thus, an oxygen source should also be present in the reactant stream. The oxygen source can be the metal/metalloid precursor itself if it comprises one or more oxygen atoms or a secondary reactant can supply the oxygen. The conditions in the reactor should be sufficiently oxidizing to produce the oxide materials.

In particular, secondary reactants can be used in some embodiments to alter the oxidizing/reducing conditions within the reaction chamber and/or to contribute non-metal/metalloid elements or a portion thereof to the reaction products. Suitable secondary reactants serving as an oxygen source include, for example, O₂, CO, H₂O, CO₂, O₃ and the like and mixtures thereof. Molecular oxygen can be supplied as air. In some embodiments, the metal/metalloid precursor compositions comprise oxygen such that all or a portion of the oxygen in product particles is contributed by the metal/metalloid precursors. Similarly, liquids used as a solvent/dispersant for aerosol delivery can similarly contribute secondary reactants, e.g., oxygen, to the reaction. In other words, if one or more metal/metalloid precursors comprise oxygen and/or if a solvent/dispersant comprises oxygen, a separate secondary reactant, e.g., a vapor reactant, may not be needed to supply oxygen for product particles. Other secondary reactants of interest are described below.

In one embodiment, a secondary reactant composition should not react significantly with the metal/metalloid precursor(s) prior to entering the radiation reaction zone since this can result in the formation of larger particles and/or damage the inlet nozzle. Similarly, if a plurality of metal/metalloid precursors is used, these precursors should not significantly react prior to entering the radiation reaction zone. If the reactants are spontaneously reactive, a metal/metalloid precursor and the secondary reactant and/or different metal/metalloid precursors can be delivered in separate reactant inlets into the reaction chamber such that they are combined just prior to reaching the light beam.

Laser pyrolysis can be performed with radiation at a variety of optical frequencies, using either a laser or other intense light source. Convenient light sources operate in the infrared portion of the electromagnetic spectrum, although other wavelengths can be used, such as the visible and ultraviolet regions of the spectrum. Excimer lasers can be used as ultraviolet sources. CO₂ lasers are particularly useful sources of infrared light. Infrared absorber(s) for inclusion in the reactant stream include, for example, C₂H₄, isopropyl alcohol, NH₃, SF₆, SiH₄ and O₃. O₃ can act as both an infrared absorber and as an oxygen source. The radiation absorber(s), such as the infrared absorber(s), can absorb energy from the radiation beam and distribute the energy to the other reactants to drive the pyrolysis.

Generally, the energy absorbed from the radiation beam, e.g., light beam, increases the temperature at a tremendous rate, many times the rate that heat generally would be produced by exothermic reactions under controlled condition(s). While the process generally involves nonequilibrium conditions, the temperature can be described approximately based on the energy in the absorbing region. The laser pyrolysis process is qualitatively different from the process in a combustion reactor where an energy source initiates a reaction, but the reaction is driven by energy given off by an exothermic reaction. Thus, while the light driven process is referred to as laser pyrolysis, it is not a traditional pyrolysis since the reaction is not driven by energy given off by the reaction but by energy absorbed from a radiation beam. In particular, spontaneous reaction of the reactants generally does not proceed significantly, if at all, back down the reactant flow toward the nozzle from the intersection of the radiation beam with the reactant stream. If necessary, the flow can be modified such that the reaction zone remains confined as desired.

An inert shielding gas can be used to reduce the amount of reactant and product molecules contacting the reactant chamber components. Inert gases can also be introduced into the reactant stream as a carrier gas and/or as a reaction moderator. Appropriate inert gases generally include, for example, Ar, He and N₂.

The particle production rate based on reactant delivery configurations described below can yield particle production rates in the range(s) of at least about 50 g/h, in other embodiments in the range(s) of at least about 100 g/h, in further embodiments in the range(s) of at least about 250 g/h, in additional embodiments in the range(s) of at least about 1 kilogram per hour (kg/h) and in general up in the range(s) up to at least about 10 kg/h. In general, these high production rates can be achieved while obtaining relatively high reaction yields, as evaluated by the portion of metal/metalloid nuclei in the flow that are incorporated into the product particles. In general, the yield can be in the range(s) of at least about 30 percent based on the limiting reactant, in other embodiments in the range(s) of at least about 50 percent, in further embodiments in the range(s) of at least about 65 percent, in other embodiments in the range(s) of at least about 80 percent and in additional embodiments in the range(s) of at least about 95 percent based on the metal/metalloid nuclei in the reactant flow. A person of ordinary skill in the art will recognize that additional values of particle production rate and yield within these specific values are contemplated and are within the present disclosure.

An appropriate laser pyrolysis apparatus generally comprises a reaction chamber isolated from the ambient environment. A reactant inlet connected to a reactant delivery apparatus generates a reactant stream as a flow through the reaction chamber. A radiation beam path, e.g., a light beam path, intersects the reactant stream at a reaction zone. The reactant/product stream continues after the reaction zone to an outlet, where the reactant/product stream exits the reaction chamber and passes into a collection apparatus. In some embodiments, the radiation source, such as a laser, is located external to the reaction chamber, and the light beam enters the reaction chamber through an appropriate window and/or lens. The dimensions of the reactant inlet(s) can be selected in part to obtain a desired production rate, although the dimensions of the reactant inlets and the flow rate should be correlated with the other reaction parameters, as described above and below, to obtain desired particle properties.

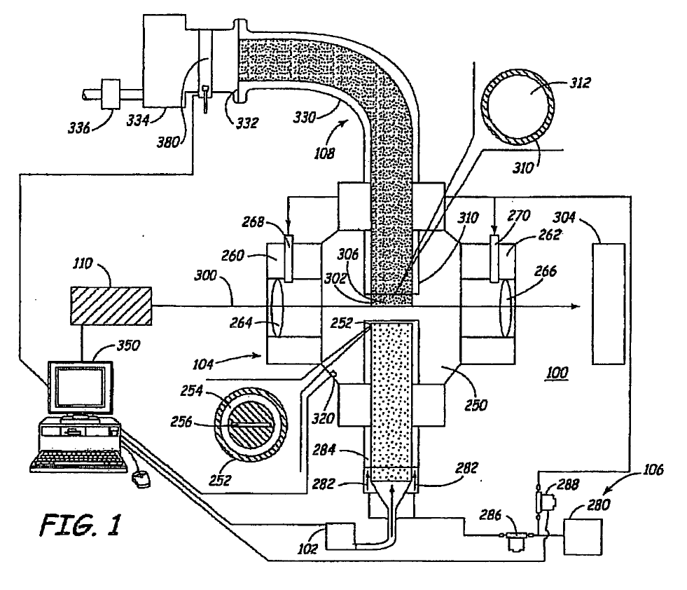

Referring to FIG. 1, a particular embodiment 100 of a laser pyrolysis system involves a reactant delivery apparatus 102, reaction chamber 104, shielding gas delivery apparatus 106, collection apparatus 108 and radiation (e.g., light) source 110. A first reaction delivery apparatus described below can be used to deliver one or more exclusively gaseous/vapor reactants. An alternative reactant delivery apparatus is described for delivery of one or more reactants as an aerosol. Similarly, a reactant delivery apparatus can permit delivery of one or more reactants as an aerosol and one or more reactants as a vapor/gas.

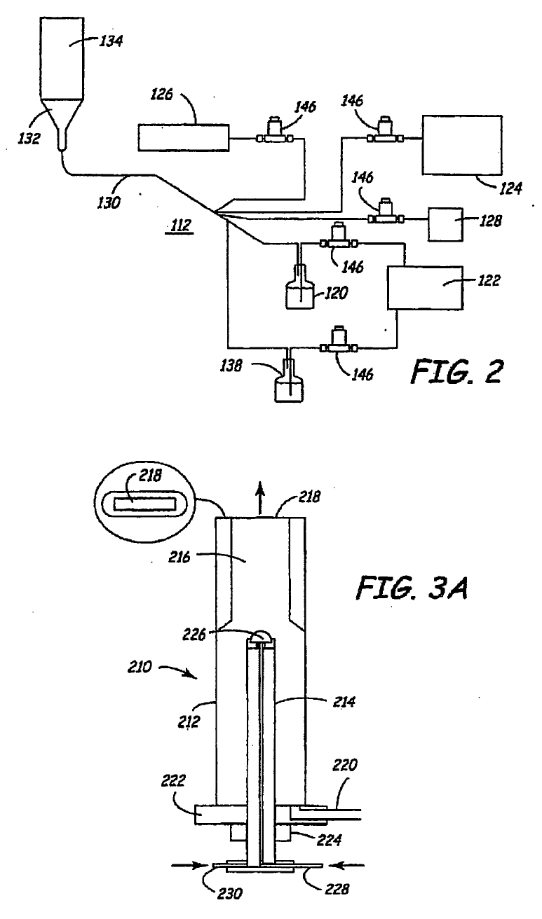

Referring to FIG. 2, a first embodiment 112 of reactant delivery apparatus 102 includes a source 120 of a precursor composition. For liquid or solid reactants, a carrier gas from one or more carrier gas sources 122 can be introduced into precursor source 120 to facilitate delivery of the reactant. Precursor source 120 can comprise a liquid holding container, a solid precursor delivery apparatus or other suitable container. The carrier gas from carrier gas source 122 can comprise an infrared absorber and/or an inert gas. In some embodiments, the precursor source comprises a flash evaporator that supplies a vapor of the precursor at a selected vapor pressure, generally without a carrier gas. The flash evaporator can be connected to a liquid reservoir to supply liquid precursor. Suitable flash evaporators are available from, for example, MKS Instruments, Inc., Albuquerque, N. Mex. or can be produced from readily available components.

The gas/vapor from precursor source 120 can be mixed with gases from infrared absorber source 124, inert gas source 126 and/or secondary reactant source 128 by combining the gases in a single portion of tubing 130. Tubing 130 can be heated to prevent condensation of precursors within the tube. The gases/vapors are combined a sufficient distance from reaction chamber 104 such that the gases/vapors become well mixed prior to their entrance into reaction chamber 104. The combined gas/vapor in tube 130 passes through a duct 132 into channel 134, which is in fluid communication with reactant inlet 256 (FIG. 1).

A second precursor/reactant can be supplied from second precursor source 138, which can be a liquid reactant delivery apparatus, a solid reactant delivery apparatus, a gas cylinder, a flash evaporator or other suitable container or containers. As shown in FIG. 2, second precursor source 138 delivers a second reactant to duct 132 by way of tube 130. In addition, mass flow controllers 146 can be used to regulate the flow of gases within the reactant delivery system of FIG. 2. In alternative embodiments, the second precursor can be delivered through a second duct for delivery into the reactant chamber through a second channel such that the reactants do not mix until they are in the reaction chamber. A laser pyrolysis apparatus with a plurality of reactant delivery nozzles is described further in copending assigned U.S. patent application Ser. No. 09/970,279 to Reitz et al., entitled “Multiple Reactant Nozzles For A Flowing Reactor,” incorporated herein by reference. One or more additional precursors, e.g., a third precursor, fourth precursor, etc., can be similarly delivered based on a generalization of the description for two precursors.

As noted above, the reactant stream can comprise one or more aerosols. The aerosols can be formed within reaction chamber 104 or outside of reaction chamber 104 prior to injection into reaction chamber 104. If the aerosols are produced prior to injection into reaction chamber 104, the aerosols can be introduced through reactant inlets comparable to those used for gaseous reactants, such as reactant inlet 256 in FIG. 1.

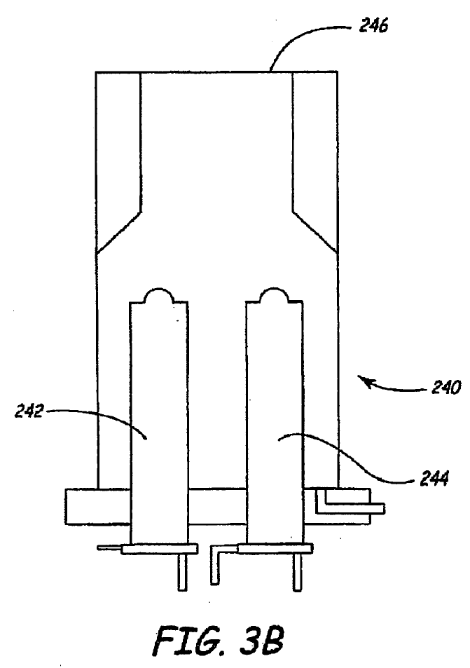

Referring to FIG. 3A, embodiment 210 of the reactant supply system 102 can be used to supply an aerosol to reaction chamber 104. Reactant supply system 210 comprises an outer nozzle 212 and an inner nozzle 214. Outer nozzle 212 has an upper channel 216 that leads to a rectangular outlet 218 at the top of outer nozzle 212, as shown in the insert in FIG. 3A. Rectangular outlet 218 has selected dimensions to produce a reactant stream of desired expanse within the reaction chamber. Outer nozzle 212 comprises a drain tube 220 in base plate 222. Drain tube 220 is used to remove condensed aerosol from outer nozzle 212. Inner nozzle 214 is secured to outer nozzle 212 at fitting 224.

The top of inner nozzle 214 can comprise a twin orifice internal mix atomizer 226. Liquid is fed to the atomizer through tube 228, and gases for introduction into the reaction chamber are fed to the atomizer through tube 230. Interaction of the gas with the liquid assists with droplet formation.

A plurality of aerosol generators can be used to produce aerosol within the reaction chamber or within one or more inlets leading to the reaction chamber. The aerosol generators can be used to generate the same or different aerosol composition from each other. For embodiments in which the aerosol generators product aerosols of different compositions, the aerosols can be used to introduce reactants/precursors that are not easily or conveniently dissolved/dispersed into the same solvent/dispersant. Thus, if a plurality of aerosol generators is used to form an aerosol directly within the reaction chamber, the aerosol generators can be oriented to mix the reactants or to deliver separate streams, possibly overlapping, along the reaction zone. If two or more aerosols are generated within a single inlet nozzle the aerosols can be mixed and flowed within a common gas flow. An inlet nozzle with two aerosol generators is shown in FIG. 3B. Inlet nozzle 240 includes aerosol generators 242, 244, which generate aerosols directed to outlet 246.

Alternatively, aerosol generators can generate aerosols within separate inlets such that the aerosols are combined within the reaction chamber. The use of a plurality of aerosol generators within a single inlet nozzle or a plurality of inlet nozzles can be useful for embodiments in which it is difficult to introduce desired compositions within a single solution/dispersion. Multiple aerosol generators producing aerosols within different inlets are described further in copending U.S. patent application Ser. No. 11/122,284 to Mosso et al., entitled “Particle Production Apparatus,” incorporated herein by reference.

In any of these aerosol embodiments, one or more vapor/gas reactants/precursors can also be introduced. For example, the vapor/gas precursors can be introduced within the aerosol generator itself to help form the aerosol. In alternative embodiments, the vapor can be delivered through a separate inlet into the delivery channel into which the aerosol is generated such that the vapor and aerosol mix and are delivered into the reaction chamber through the same reactant inlet. In further embodiments, the vapor precursors are delivered into the reaction chamber through separate reactant inlets to combine with the flow comprising the aerosol. In addition, these approaches can be combined for the delivery of a single vapor precursor, different vapor precursors through different delivery channels or a combination thereof.

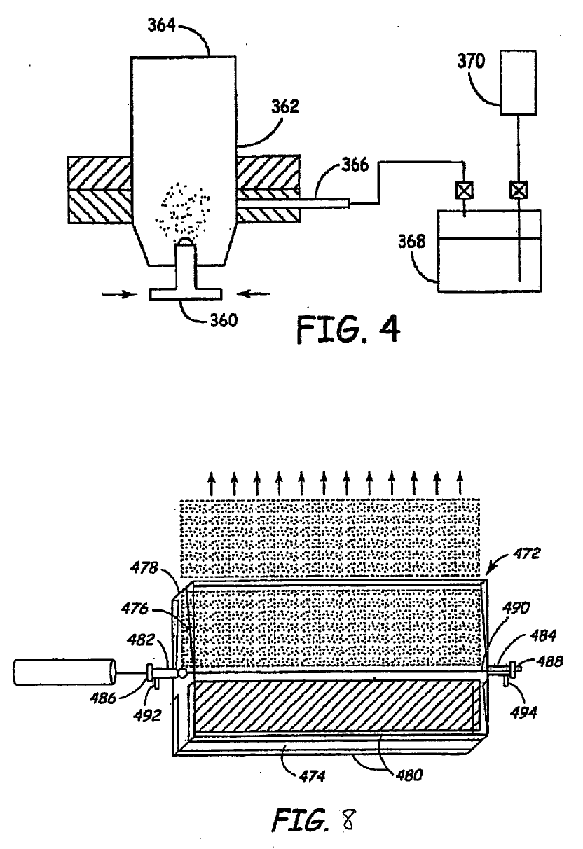

An embodiment of an inlet nozzle that is configured for delivery of a vapor precursor(s) into a channel with an aerosol for delivery together into a reaction chamber is depicted in FIG. 4. Referring to FIG. 4, aerosol generator 360 delivers an aerosol into channel 362. Channel 362 leads to reactant inlet 364 that generally leads into a reaction chamber. Reactant inlet 364 can be positioned, as desired, to deliver the reactant stream/flow a suitable distance from a radiation path within the reaction chamber. Vapor channel 366 leads into channel 362 such that vapor precursors can mix with aerosols from aerosol generator 360 for delivery through reactant inlet 364. Vapor channel 366 connects to a flash evaporator 368, although other vapor sources, such as a bubbler or solid vapor source, can be used. Flash evaporator heats a liquid precursor to a temperature to deliver a selected vapor pressure to vapor channel 366. Vapor channel 366 and/or channel 362 can be heated to reduce or eliminate condensation of vapor reactants. Flash evaporator 368 connects to a liquid source 370.

Referring to FIG. 1, the reaction chamber 104 comprises a main chamber 250. Reactant supply system 102 connects to the main chamber 250 at injection nozzle 252. Reaction chamber 104 can be heated to a surface temperature above the dew point of the mixture of reactants and inert components at the pressure in the apparatus.

The end of injection nozzle 252 has an annular opening 254 for the passage of inert shielding gas, and a reactant inlet 256 (left lower insert) for the passage of reactants to form a reactant stream in the reaction chamber. Reactant inlet 256 can be a slit, as shown in the lower inserts of FIG. 1. The flow of shielding gas through annular opening 254 helps to prevent the spread of the reactant gases and product particles throughout reaction chamber 104. In some embodiments, the shielding gas inlet has a slit shape aligned along the reactant inlet slit.

Tubular sections 260, 262 are located on either side of injection nozzle 252. Tubular sections 260, 262 can comprise, for example, ZnSe windows/lenses 264, 266, respectively. Windows 264, 266 can be, for example, about 1 inch in diameter. Windows 264, 266 can comprise cylindrical lenses with a focal length equal to the distance between the center of the chamber to the surface of the lens to focus the light beam to a point just below the center of the nozzle opening. Windows 264, 266 can further comprise an antireflective coating. Appropriate ZnSe lenses are available from Laser Power Optics, San Diego, Calif. Tubular sections 260, 262 provide for the displacement of windows 264, 266 away from main chamber 250 such that windows 264, 266 are less likely to be contaminated by reactants and/or products. Window 264, 266 are displaced, for example, about 3 cm from the edge of the main chamber 250. In place of lenses, reflective optics can be used.

Windows 264, 266 can be sealed with a rubber o-ring to tubular sections 260, 262 to prevent the flow of ambient air into reaction chamber 104. Tubular inlets 268, 270 provide for the flow of shielding gas into tubular sections 260, 262 to reduce the contamination of windows 264, 266. Tubular inlets 268, 270 are connected to shielding gas delivery apparatus 106.

Referring to FIG. 1, shielding gas delivery system 106 can comprise inert gas source 280 connected to an inert gas duct 282. Inert gas duct 282 flows into annular channel 284 leading to annular opening 254. A mass flow controller 286 can regulate the flow of inert gas into inert gas duct 282. If reactant delivery system 112 of FIG. 2 is used, inert gas source 126 can also function as the inert gas source for duct 282, if desired. Referring to FIG. 1, inert gas source 280 or a separate inert gas source can be used to supply inert gas to tubes 268, 270. Flow to tubes 268, 270 can be controlled by a mass flow controller 288.

Radiation source 110 is aligned to generate an electromagnetic radiation, e.g., light, beam 300 that enters window 264 and exits window 266. Windows/lenses 264, 266 define a light path through main chamber 250 intersecting the flow of reactants at reaction zone 302. After exiting window 266, electromagnetic radiation beam 300 strikes power meter 304, which also acts as a beam dump. An appropriate power meter is available from Coherent Inc., Auburn, Calif. Radiation source 110 can be a laser or an intense conventional light source such as an arc lamp. In one embodiment, radiation source 110 is an infrared laser, especially a CW CO₂ laser such as an 1800 watt maximum power output laser available from PRC Corp., Landing, N.J.

Reactants passing through reactant inlet 256 in injection nozzle 252 result in a reactant stream. The reactant stream passes through reaction zone 302, where reaction involving the metal/metalloid precursor composition(s) and dopant/additive precursor composition(s) takes place. Heating of the gases in reaction zone 302 is extremely rapid, roughly on the order of about 10⁵ degree C./sec depending on the specific conditions. The reaction is rapidly quenched upon leaving reaction zone 302, and particles 306 are formed in the reactant/product stream. The nonequilibrium nature of the process can lead to the production of submircon/nanoparticles with a highly uniform size distribution and structural homogeneity.

The path of the reactant stream continues to collection nozzle 310. Collection nozzle 310 can have a circular opening 312, as shown in the upper insert of FIG. 1. Circular opening 312 feeds into collection system 108.

The chamber pressure can be monitored with a pressure gauge 320 attached to the main chamber. A suitable chamber pressure for the production of the desired oxides generally is in the range(s) from about 80 Torr to about 750 Torr.

Collection system 108 can comprise a curved channel 330 leading from collection nozzle 310. Because of the small size of the particles, the product particles follow the flow of the gas around curves. Collection system 108 can comprise a filter 332 within the gas flow to collect the product particles. Due to curved section 330, the filter is not supported directly above the chamber. A variety of materials such as Teflon® (polytetrafluoro-ethylene), stainless steel, glass fibers and the like can be used for the filter as long as the material is substantially inert and has a fine enough mesh to trap the particles. Suitable materials for the filter include, for example, a glass fiber filter from ACE Glass Inc., Vineland, N.J., cylindrical Nomex® filters from AF Equipment Co., Sunnyvale, Calif. and stainless steel filters from All Con World Systems, Seaford, Del. Filters can be replaced with electrostatic collectors.

Pump 334 can be used to maintain collection system 108 at a selected pressure. It may be desirable to flow the exhaust of the pump through a scrubber 336 to remove any remaining reactive chemicals before venting into the atmosphere.

The pumping rate can be controlled by either a manual needle valve or an automatic throttle valve 338 inserted between pump 334 and filter 332. As the chamber pressure increases due to the accumulation of particles on filter 332, the manual valve or the throttle valve can be adjusted to maintain the pumping rate and the corresponding chamber pressure.

The apparatus can be controlled by a computer 350 or a corresponding control system. Generally, the computer controls the radiation (e.g., light) source and monitors the pressure in the reaction chamber. The computer can be used to control the flow of reactants and/or the shielding gas.

The reaction can be continued until sufficient particles are collected on filter 332 such that pump 334 can no longer maintain the desired pressure in the reaction chamber 104 against the resistance through filter 332. When the pressure in reaction chamber 104 can no longer be maintained at the desired value, the reaction can be stopped, and filter 332 can be removed. With this embodiment, about 1-300 grams of particles can be collected in a single run before the chamber pressure can no longer be maintained. A single run generally can last up to about 10 hours depending on the reactant delivery system, the type of particle being produced and the type of filter being used. Continuous powder production and collection systems as well as systems with higher production rates are described below.

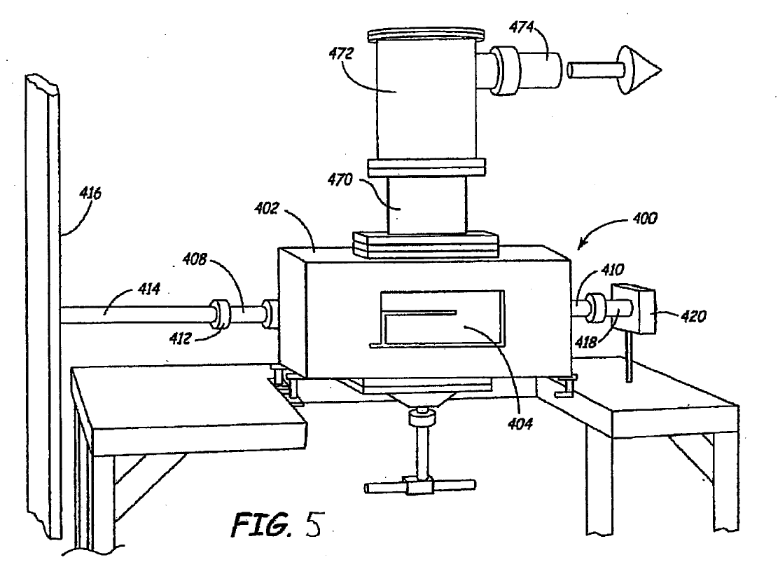

An alternative embodiment of a laser pyrolysis apparatus is shown in FIG. 5. Laser pyrolysis apparatus 400 comprises a reaction chamber 402. The reaction chamber 402 comprises a shape of a rectangular parallelepiped. Reaction chamber 402 extends with its longest dimension along the laser beam. Reaction chamber 402 can have a viewing window 404 at its side, such that the reaction zone can be observed during operation.

Reaction chamber 402 further comprises tubular extensions 408, 410 that define an optical path through the reaction chamber. Tubular extension 408 can be connected with a seal to a cylindrical lens 412. Tube 414 connects laser 416 or other optical radiation source with lens 412. Similarly, tubular extension 410 can be connected with a seal to tube 418, which further leads to beam dump/light meter 420. Thus, the entire light path from optical radiation source 416 to beam dump 420 can be enclosed.

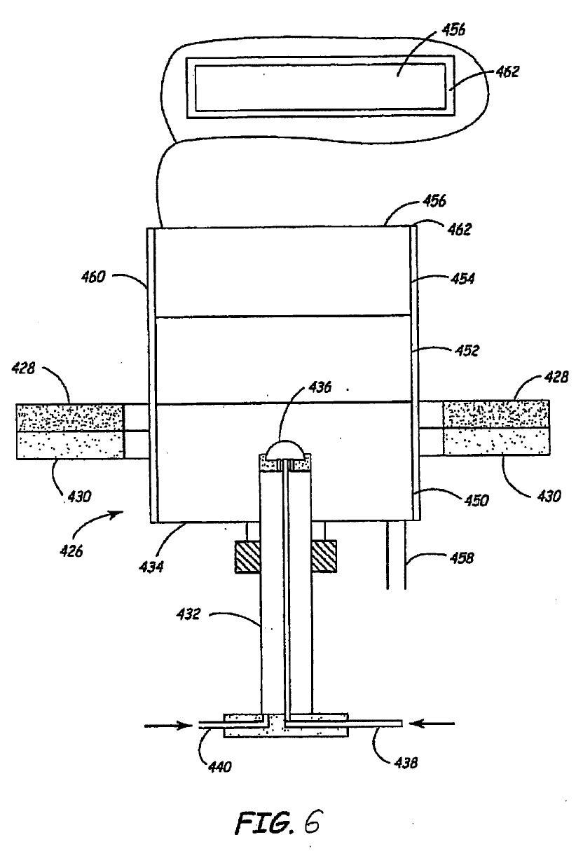

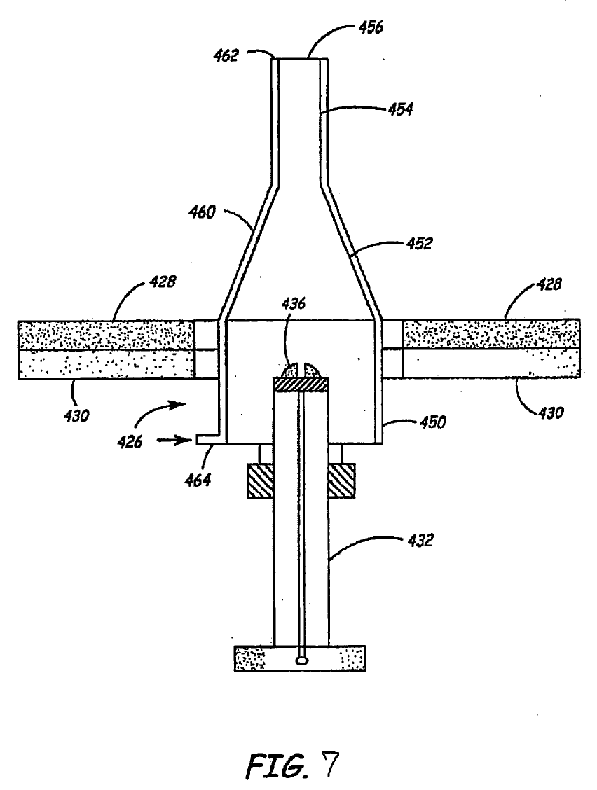

In this embodiment, inlet nozzle 426 connects with reaction chamber 402 at its lower surface 428. Inlet nozzle 426 comprises a plate 430 that bolts into lower surface 428 to secure inlet nozzle 426. Referring to sectional views in FIGS. 6 and 7, inlet nozzle 426 comprises an inner nozzle 432 and an outer nozzle 434. Inner nozzle 432 can have a twin orifice internal mix atomizer 436 at the top of the nozzle. Suitable gas atomizers are available from Spraying Systems, Wheaton, Ill. The twin orifice internal mix atomizer 436 has a fan shape to produce a thin sheet of aerosol and gaseous precursors. Liquid is fed to the atomizer through tube 438, and gases for introduction into the reaction chamber are fed to the atomizer through tube 440. Interaction of the gas with the liquid assists with droplet formation.

Outer nozzle 434 comprises a chamber section 450, a funnel section 452 and a delivery section 454. Chamber section 450 holds the atomizer of inner nozzle 432. Funnel section 452 directs the aerosol and gaseous precursors into delivery section 454. Delivery section 450 leads to an about 3 inch by 0.5 inch rectangular outlet 456, shown in the insert of FIG. 6. Outer nozzle 434 comprises a drain 458 to remove any liquid that collects in the outer nozzle. Outer nozzle 434 is covered by an outer wall 460 that forms a shielding gas opening 462 surrounding outlet 456. Inert gas is introduced through inlet 464. The nozzle in FIGS. 6 and 7 can be adapted for the delivery of aerosol and vapor precursors as discussed above with respect to FIGS. 3 and 4.

Referring to FIG. 5, exit nozzle 470 connects to apparatus 400 at the top surface of reaction chamber 402. Exit nozzle 470 leads to filter chamber 472. Filter chamber 472 connects with pipe 474, which leads to a pump. A cylindrical filter is mounted at the opening to pipe 474. Suitable cylindrical filters are described above.

Another alternative design of a laser pyrolysis apparatus has been described in U.S. Pat. No. 5,958,348 to Bi et al., entitled “Efficient Production of Particles by Chemical Reaction,” incorporated herein by reference. This alternative design is intended to facilitate production of commercial quantities of particles by laser pyrolysis. Additional embodiments and other appropriate features for commercial capacity laser pyrolysis apparatuses are described in copending U.S. patent application Ser. No. 11/122,284 to Mosso et al., entitled “Particle Production Apparatus,” incorporated herein by reference.

In one embodiment of a commercial capacity laser pyrolysis apparatus, the reaction chamber and reactant inlet are elongated significantly along the light beam to provide for an increase in the throughput of reactants and products. The embodiments described above for the delivery of aerosol reactants can be adapted for the elongated reaction chamber design. Additional embodiments for the introduction of an aerosol with one or more aerosol generators into an elongated reaction chamber are described in U.S. Pat. No. 6,193,936 to Gardner et al., entitled “Reactant Delivery Apparatuses,” incorporated herein by reference. A combination of vapor and aerosol precursors can be delivered into this reaction chamber by generalizing the approaches discussed above with respect to FIGS. 3 and 4.

In general, the laser pyrolysis apparatus with the elongated reaction chamber and reactant inlet is designed to reduce contamination of the chamber walls, to increase the production capacity and/or to make efficient use of resources. To accomplish these objective(s), the elongated reaction chamber provides for an increased throughput of reactants and products without a corresponding increase in the dead volume of the chamber. The dead volume of the chamber can become contaminated with unreacted compositions and/or reaction products. Furthermore, an appropriate flow of shielding gas confines the reactants and products within a flow stream through the reaction chamber. The high throughput of reactants makes efficient use of the laser energy.

The design of the improved reaction chamber 472 is shown schematically in FIG. 8. A reactant inlet 474 leads to main chamber 476. Reactant inlet 474 conforms generally to the shape of main chamber 476. Main chamber 476 includes an outlet 478 along the reactant/product stream for removal of particulate products, any unreacted gases and inert gases. The configuration can be reversed with the reactants supplied from the top and product collected from the bottom, if desired. Shielding gas inlets 480 are located on both sides of reactant inlet 474. Shielding gas inlets are used to form a blanket of inert gases on the sides of the reactant stream to inhibit contact between the chamber walls and the reactants or products. The dimensions of elongated main chamber 476 and reactant inlet 474 can be designed for high efficiency particle production.

Reasonable lengths for reactant inlet 474 for the production of ceramic submicron/nanoscale particles, when used with an 1800 watt CO₂ laser, are in the range(s) from about 5 mm to about 1 meter. More specifically with respect to the reactant inlet, the inlet generally has an elongated dimension in the range(s) of at least about 0.5 inches (1.28 cm), in other embodiments in the range(s) of at least about 1.5 inches (3.85 cm), in other embodiments in the range(s) of at least about 2 inches (5.13 cm), in further embodiments in the range(s) of at least about 3 inches (7.69 cm), in further embodiments in the range(s) of at least about 5 inches (12.82 cm) and in additional embodiments in the range(s) from about 8 inches (20.51 cm) to about 200 inches (5.13 meters). A person of ordinary skill in the art will recognize that additional ranges of inlet lengths within these specific ranges are contemplated and are within the present disclosure.

In addition, the inlet can be characterized by an aspect ratio that is the ratio of the length divided by the width. If the inlet is not rectangular, the aspect ratio can be evaluated using the longest dimension as the length and the width as the largest dimension perpendicular to the line segment along the length. In some embodiments, the aspect ratio is in the range(s) of at least about 5, in other embodiments in the range(s) of at least about 10 and in further embodiments, in the range(s) from about 50 to about 400. A person of ordinary skill in the art will recognize that additional ranges of aspect ratio within these explicit ranges of aspect ratio are contemplated and are within the present disclosure. Nozzle parameters for particle production by laser pyrolysis are described further in U.S. Pat. No. 6,919,054 to Gardner et al., entitled “Reactant Nozzles Within Flowing Reactors,” incorporated herein by reference.

To obtain high yields at high production rates, the radiation beam can be directed to intersect with a significant fraction or the entire reactant flow. For a rectangular reactant inlet, the widest width of the reactant flow can be less than the narrowest width of a radiation beam. If the beam is focused with a cylindrical lens, the lens can be oriented to focus the beam orthogonal to the flow such that the beam does not narrow relative to the width of the flow. Thus, a high production rate can be achieved while efficiently using resources. In general, the radiation beam and the reactant flow can be configured such that effectively none of reactant flow is excluded from the path of the radiation beam. In some embodiments, the radiation beam intersect with at least about 80 volume percent of the reactant flow, in other embodiment at least about 90 volume percent, in further embodiments at least about 95 volume percent and in additional embodiments at least about 99 volume percent of the reactant flow, which can be considered to exclude effectively none of the reactant flow from the path of the radiation beam.

Tubular sections 482, 484 can extend from the main chamber 476. Also, tubular sections 482, 484 can hold windows/lenses 486, 488 to define a light beam path 490 through the reaction chamber 472. Tubular sections 482, 484 can comprise inert gas inlets 492, 494 for the introduction of inert gas into tubular sections 482, 484.

The reaction system comprises a collection apparatus to remove the submicron/nanoscale particles from the reactant stream. The collection system can be designed to collect particles in a batch mode with the collection of a large quantity of particles prior to terminating production. A filter or the like can be used to collect the particles in batch mode. Alternatively, the collection system can be designed to run in a continuous production mode by switching between different particle collectors within the collection apparatus or by providing for removal of particles without exposing the collection system to the ambient atmosphere. A suitable embodiment of a collection apparatus for continuous particle production and collection is described in U.S. Pat. No. 6,270,732 to Gardner et al., entitled “Particle Collection Apparatus And Associated Methods,” incorporated herein by reference.

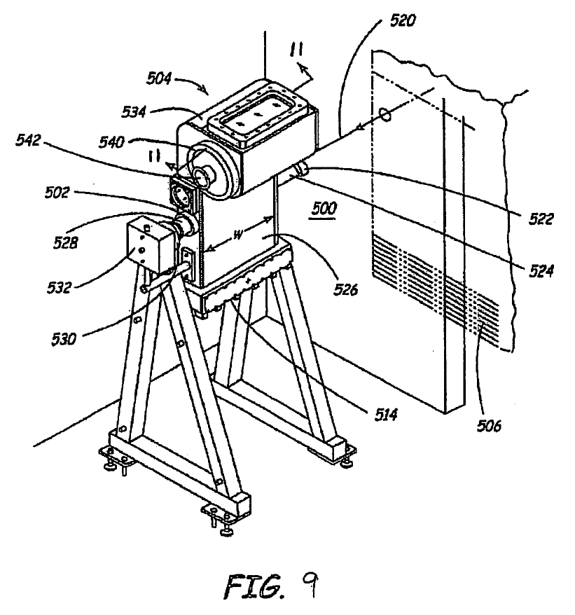

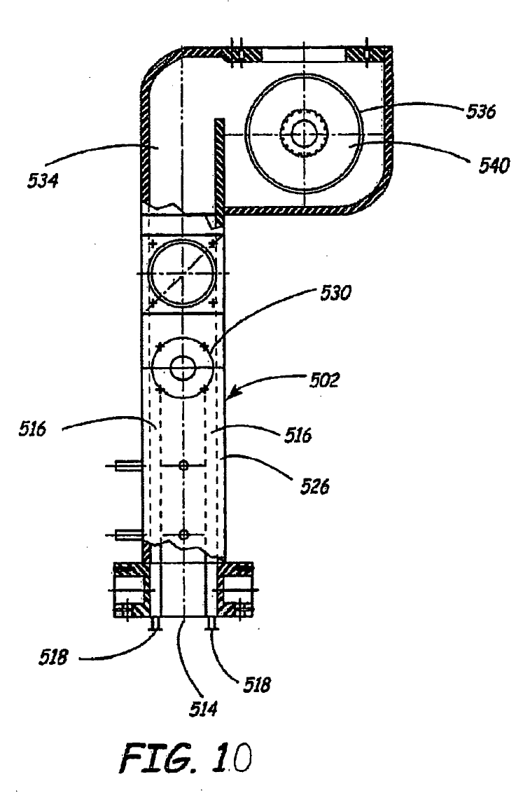

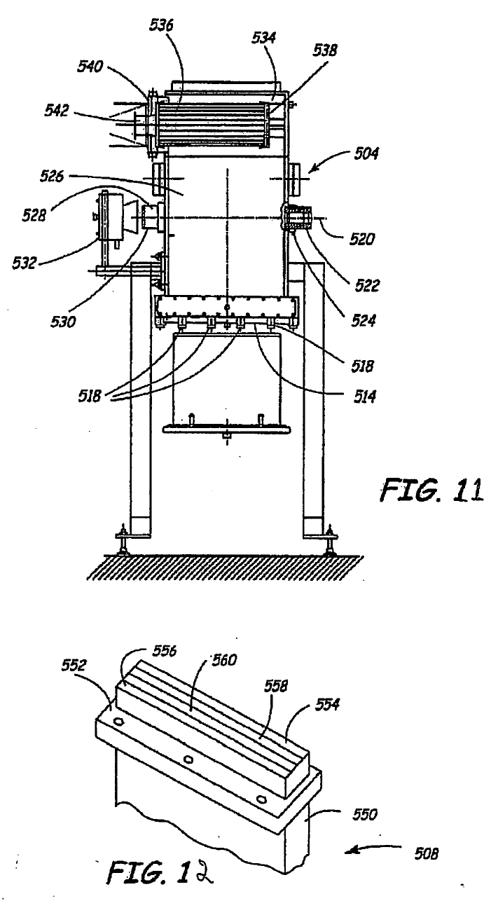

Referring to FIGS. 9-11 a specific embodiment of a laser pyrolysis reaction system 500 includes reaction chamber 502, a particle collection system 504, laser 506 and a reactant delivery system 508. Reaction chamber 502 comprises reactant inlet 514 at the bottom of reaction chamber 502 where reactant delivery system 508 connects with reaction chamber 502. In this embodiment, the reactants are delivered from the bottom of the reaction chamber while the products are collected from the top of the reaction chamber.

Shielding gas conduits 516 are located on the front and back of reactant inlet 514. Inert gas is delivered to shielding gas conduits 516 through ports 518. The shielding gas conduits direct shielding gas along the walls of reaction chamber 502 to inhibit association of reactant gases or products with the walls.

Reaction chamber 502 is elongated along one dimension denoted in FIG. 9 by “w”. A radiation, e.g., light or laser, beam path 520 enters the reaction chamber through a window 522 displaced along a tube 524 from the main chamber 526 and traverses the elongated direction of reaction chamber 502. The radiation beam passes through tube 528 and exits window 530. In one particular embodiment, tubes 524 and 528 displace windows 522 and 530 about 11 inches from the main chamber. The radiation beam terminates at beam dump 532. In operation, the radiation beam intersects a reactant stream generated through reactant inlet 514.

The top of main chamber 526 opens into particle collection system 504. Particle collection system 504 comprises outlet duct 534 connected to the top of main chamber 526 to receive the flow from main chamber 526. Outlet duct 534 carries the product particles out of the plane of the reactant stream to a cylindrical filter 536. Filter 536 has a cap 538 on one end. The other end of filter 536 is fastened to disc 540. Vent 542 is secured to the center of disc 540 to provide access to the center of filter 536. Vent 542 is attached by way of ducts to a pump. Thus, product particles are trapped on filter 536 by the flow from the reaction chamber 502 to the pump. Suitable pumps were described above. Suitable filters include, for example, an air cleaner filter for a Saab 9000 automobile (Pur-o-lator part A44-67), which comprises wax impregnated paper with Plastisol or polyurethane end caps.

In a specific embodiment, reactant delivery system 508 comprises a reactant nozzle 550, as shown in FIG. 12. Reactant nozzle 550 can comprise an attachment plate 552. Reactant nozzle 550 attaches at reactant inlet 514 with attachment plate 552 bolting to the bottom of main chamber 526. In one embodiment, nozzle 550 has four channels that terminate at four slits 554, 556, 558, 560. Slits 558 and 560 can be used for the delivery of precursors and other desired components of the reactant stream. Slits 554, 556 can be used for the delivery of inert shielding gas. If a secondary reactant is spontaneously reactive with the vanadium precursor, it can be delivered also through slits 554, 556. One apparatus used for the production of oxide particles had dimensions for slits 554, 556, 558, 560 of 3 inches by 0.04 inches.

### Heat Processing

Significant properties of submicron/nanoscale particles can be modified by heat processing. Suitable starting materials for the heat treatment include particles produced by laser pyrolysis. In addition, particles used as starting material for a heat treatment process can have been subjected to one or more prior heating steps under different conditions. For the heat processing of particles formed by laser pyrolysis or other method, the additional heat processing can improve/alter the crystallinity, remove contaminants, such as elemental carbon, and/or alter the stoichiometry, for example, by incorporation of additional oxygen or another element or removal of oxygen or another element to change the oxidation state of a metal/metalloid element. Furthermore, a heat processing process can be used to alter the composition of the particles, for example, by the introduction of another metal/metalloid element(s) into the particles, which can be accompanied by changes in other elements, such as oxygen, also.

In some embodiments of interest, mixed metal/metalloid compositions, such as metal/metalloid oxides, formed by laser pyrolysis can be subjected to a heat processing step. This heat processing can convert the particles into desired high quality crystalline forms, if not formed in a desired form. The heat treatment can be controlled to substantially maintain the submicron/nanoscale size and size uniformity of the particles from laser pyrolysis. In other words, particle size is not compromised significantly by thermal processing.

The particles can be heated in an oven or the like to provide generally uniform heating. The processing conditions generally are mild, such that a significant amount of particle sintering does not occur. Thus, the temperature of heating can be low relative to the melting point of the starting material and the product material.

The atmosphere over the particles can be static, or gases can be flowed through the system. The atmosphere for the heating process can be an oxidizing atmosphere, a reducing atmosphere, or an inert atmosphere. In particular, for conversion of amorphous particles to crystalline particles or from one crystalline structure to a different crystalline structure of essentially the same stoichiometry, the atmosphere generally can be inert.

Appropriate oxidizing gases include, for example, O₂, O₃ and combinations thereof. The O₂ can be supplied as air. Reducing gases include, for example, H₂ and NH₃. Oxidizing gases or reducing gases optionally can be mixed with inert gases such as Ar, He and N₂. When inert gas is mixed with the oxidizing/reducing gas, the gas mixture can include in the range(s) from about 1 percent oxidizing/reducing gas to about 99 percent oxidizing/reducing gas, and in other embodiments in the range(s) from about 5 percent oxidizing/reducing gas to about 99 percent oxidizing/reducing gas. Alternatively, essentially pure oxidizing gas, pure reducing gas or pure inert gas can be used, as desired. Care must be taken with respect to the prevention of explosions when using highly concentrated reducing gases.

The oxidizing/reducing nature of the gas flow can be adjusted to yield desired oxidation states of metal/metalloid elements in the particles. Similarly, with respect to doped inorganic particles, the heating process and associated gases may account for desired oxidation states of the dopants. For example, a reducing atmosphere can be used for the heat treatment of BaMgAl₁₄O₂₃ doped with europium since the europium is generally supplied in a +3 state while it operates as a phosphor activator in a +2 state. The laser pyrolysis synthesis of BaMgAl₁₄O₂₃ doped with europium and of YO₃ doped with europium using laser pyrolysis is discussed in U.S. Pat. No. 6,692,660 to Kumar, entitled “High Luminescence Phosphor Particles And Related Particle Compositions,” incorporated herein by reference.

The precise conditions can be altered to vary the type of metal/metalloid oxide particles that are produced. For example, the temperature, time of heating, heating and cooling rates, the surrounding gases and the exposure conditions with respect to the gases can all be selected to produce desired product particles. Generally, while heating under an oxidizing atmosphere, with a longer the heating period, more oxygen is incorporated into the material, prior to reaching equilibrium. Once equilibrium conditions are reached within the oven, the overall conditions determine the crystalline phase of the powders.

A variety of ovens or the like can be used to perform the heating. An example of an apparatus 600 to perform this processing is displayed in FIG. 13. Apparatus 600 includes a jar 602, which can be made from glass or other inert material, into which the particles are placed. Suitable glass reactor jars are available from Ace Glass (Vineland, N.J.). For higher temperatures alloy jars can be used to replace the glass jars. The top of glass jar 602 can be sealed to a glass cap 604, with a Teflon® gasket 606 between jar 602 and cap 604. Cap 604 can be held in place with one or more clamps. Cap 604 generally has a plurality of ports 608, each with a Teflon® bushing. A multiblade stainless steel stirrer 610 can be inserted through a central port 608 in cap 604 to mix the powders during the heating process. Stirrer 610 is connected to a suitable motor.

One or more tubes 612 can be inserted through ports 608 for the delivery of gases into jar 602. Tubes 612 can be made from stainless steel or other inert material. Diffusers 614 can be included at the tips of tubes 612 to disburse the gas within jar 602. A heater/furnace 616 generally is placed around jar 602. Suitable resistance heaters are available from Glas-col (Terre Haute, Ind.). One port preferably includes a T-connection 618. The temperature within jar 602 can be measured with a thermocouple 618 inserted through T-connection 618. T-connection 618 can be further connected to a vent 620. Vent 620 provides for the venting of gas circulated through jar 602. Vent 620 can be vented to a fume hood or alternative ventilation equipment. A thermocouple or thermometer 622 can be used to monitor the temperature in the jar.

In appropriate embodiments, desired gases are flowed through jar 602. Tubes 612 generally are connected to an oxidizing gas source, a reducing gas source and/or an inert gas source. Oxidizing gas, reducing gas, inert gas or a combination thereof to produce the desired atmosphere are placed within jar 602 from the appropriate gas source(s). Various flow rates can be used. In some embodiments, the flow rate can be between about 1 standard cubic centimeter per minute (sccm) to about 1000 sccm and in further embodiments from about 10 sccm to about 500 sccm. The flow rate generally is constant through the processing step, although the flow rate and the composition of the gas can be varied systematically over time during processing, if desired. Alternatively, a static gas atmosphere can be used.

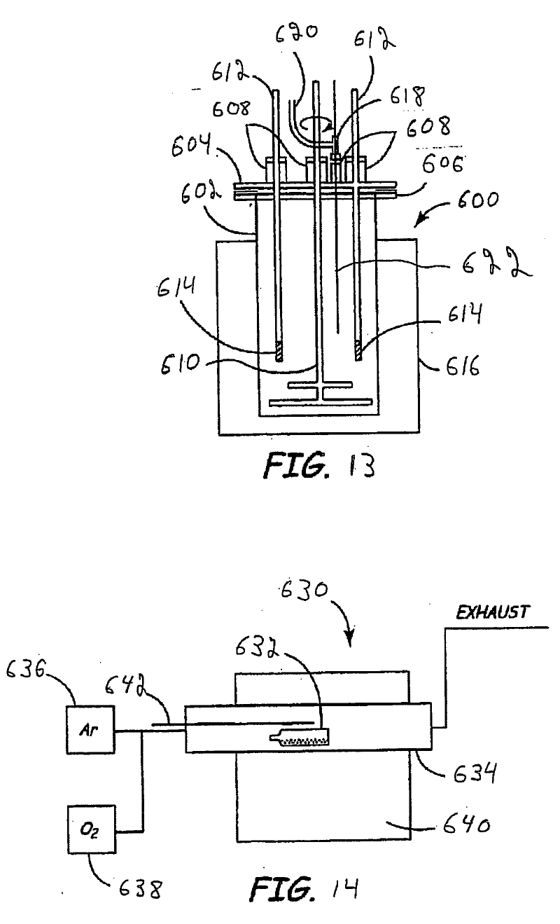

An alternative apparatus 630 for the heat treatment of modest quantities of submicron particles is shown in FIG. 14. The particles are placed within a boat 632 or the like within tube 634. Tube 634 can be produced from, for example, quartz, alumina or zirconia. In some embodiments, the desired gases are flowed through tube 634. Gases can be supplied for example from inert gas source 636 or oxidizing gas source 638.

Tube 634 is located within oven or furnace 640. Oven 640 can be adapted from a commercial furnace, such as Mini-Mite™ 1100° C. Tube Furnace from Lindberg/Blue M, Asheville, N.C. Oven 640 maintains the relevant portions of the tube at a relatively constant temperature, although the temperature can be varied systematically through the processing step, if desired. The temperature can be monitored with a thermocouple 642.

Desirable temperature ranges depend on the starting material and the target product inorganic particles. For the processing of submicron phosphors, suitable temperatures generally can range from about 400° C. to about 1400° C. The particular temperatures will depend on the specific material being processed. The heating generally is continued for greater than about 5 minutes, and typically is continued for from about 10 minutes to about 120 hours, in most circumstances from about 10 minutes to about 5 hours. Suitable heating times also will depend on the particular starting material and target product. Some empirical adjustment may be helpful to produce the conditions appropriate for yielding a desired material. Typically, submicron and nanoscale powders can be processed at lower temperatures while still achieving the desired result. The use of mild conditions avoids significant interparticle sintering resulting in larger particle sizes. To prevent particle growth, the particles can be heated for short periods of time at high temperatures or for longer periods of time at lower temperatures. Some controlled sintering of the particles can be performed at somewhat higher temperatures to produce slightly larger, average particle diameters.

For the heat treatment of submicron phosphor particles, it can be desirable to use a multi-step heat treatment process. In particular, at least a two or a three step process may be desirable. A first heat treatment step can be performed at relatively low temperature for relatively short times under relatively oxidizing conditions, such as with air, to remove impurities, such as carbon, from the particles, while reducing or eliminating any undesired oxidation of the dopant. A second heating step can be performed at a higher temperature under inert or reducing conditions, such as with an inert gas or H₂, to convert the particles to the desired crystalline phase at a temperature determined by the phase diagram of the material. A third longer heating step at lower temperatures can be used, under inert or reducing atmospheric conditions, to further improve the crystallinity of the particles, relax the crystal structure and reduce defects in the crystal lattice. The first heating step can be performed from about 250° C. to about 600° C. for from about 5 minutes to about five hours, in some embodiments from abut 5 minutes to about two hours and in further embodiments from about 5 minutes to about one hour. In general, this first heating step should be suitable for a wide range of inorganic materials and has been shown to be suitable for YAG:Ce.

The second heating step can be performed at a second temperature for 15 minutes to about 48 hours, with longer anneal times generally being used at relatively lower temperatures. The second temperature is generally higher than the first temperature and is generally at least above a transformation onset temperature of the desired crystalline phase and 100° C. below the melting temperature of the particles. For YAG:Ce, a suitable second temperature ranges from about 950° C. to about 1250° C. The third heating step can be carried out for about 30 minutes to about 24 hours or longer at a third temperature less than the second temperature and greater than the first temperature, which is selected to improve the crystallinity as determined by x-ray diffraction without causing significant sintering. For YAG:Ce suitable third temperatures range from about 450° C. to about 700° C. The use of these different heating steps provides for relatively stable and correct dopant oxidation state, little sintering, high crystallinity, narrow particle size distribution, a purer structure and less defects. Of course, additional heating steps can be used, and similarly the above heating steps can be subdivided. Also, the heating and cooling rates can be selected reasonably based on this discussion.

As noted above, heat treatment can be used to perform a variety of desirable transformations for submicron/nanoscale particles. For example, the conditions to convert crystalline VO₂ to orthorhombic V₂O₅ and 2-D crystalline V₂O₅, and amorphous V₂O₅ to orthorhombic V₂O₅ and 2-D crystalline V₂O₅ are describe in U.S. Pat. No. 5,989,514, to Bi et al., entitled “Processing of Vanadium Oxide Particles With Heat,” incorporated herein by reference. Conditions for the removal of carbon coatings from metal oxide submicron/nanoscale particles is described in U.S. Pat. No. 6,387,531, entitled “Metal (Silicon) Oxide/Carbon Composite Particles,” incorporated herein by reference. The incorporation of lithium from a lithium salt into metal oxide submicron/nanoscale particles in a heat treatment process is described in U.S. Pat. No. 6,136,287 to Home et al., entitled “Lithium Manganese Oxides And Batteries,” and copending and commonly assigned U.S. patent application Ser. No. 09/334,203 to Kumar et al., entitled “Reaction Methods for Producing Ternary Particles,” both of which are incorporated herein by reference. The incorporation of silver metal into vanadium oxide particles through a heat treatment is described in U.S. Pat. No. 6,225,007 to Home et al., entitled “Metal Vanadium Oxide,” incorporated herein by reference. For metal incorporation into vanadium oxide, the temperature is generally in the range(s) from about 200° C. to about 500° C. and in other embodiments in the range(s) from about 250° C. to about 375° C.

### Particle Properties

A collection of inorganic particles of interest generally has an average diameter for the primary particles of less than about 1000 nm, in most embodiments less than about 500 nm, in other embodiments from about 2 nm to about 100 nm, in further embodiments from about 3 nm to about 75 nm, and still other embodiments from about 5 nm to about 50 nm. In some embodiments involving selected compositions, the average particle sizes range from about 15 nm to about 100 nm, or from about 15 nm to about 50 nm. A person of ordinary skill in the art will recognize that average diameter ranges within these specific ranges are also contemplated and are within the present disclosure. Particle diameters generally are evaluated by transmission electron microscopy. Diameter measurements on particles with asymmetries are based on an average of length measurements along the principle axes of the particle. Secondary particle sizes following dispersion are described further below in a later section.

For many inorganic compositions, the primary particles can have a roughly spherical gross appearance. Also, crystalline primary particles tend to exhibit growth in laser pyrolysis that is roughly equal in the three physical dimensions to give a gross spherical appearance. For some compositions, after heat treatment, the inorganic particles may be less spherical. Upon closer examination, crystalline particles generally have facets corresponding to the underlying crystal lattice. Amorphous particles generally have an even more spherical aspect. In some embodiments, 95 percent of the primary particles, and in other embodiments 99 percent, have ratios of the dimension along the major axis to the dimension along the minor axis less than about 2.

Because of their small size, the primary particles tend to form loose agglomerates due to forces between nearby particles. These agglomerates can be dispersed to a significant degree, if desired. Even though the particles form loose agglomerates, the nanometer scale of the primary particles is clearly observable in transmission electron micrographs of the particles. The particles generally have a surface area corresponding to particles on a nanometer scale as observed in the micrographs. Furthermore, the particles can manifest unique properties due to their small size and large surface area per weight of material. For example, vanadium oxide nanoparticles can exhibit surprisingly high energy densities in lithium batteries, as described in U.S. Pat. No. 5,952,125 to Bi et al., entitled “Batteries With Electroactive Nanoparticles,” incorporated herein by reference.

The primary particles can have a high degree of uniformity in size. Laser pyrolysis, as described above, generally results in particles having a very narrow range of particle diameters. Furthermore, heat processing under suitably mild conditions does not alter the very narrow range of particle diameters. With aerosol delivery of reactants for laser pyrolysis, the distribution of particle diameters is particularly sensitive to the reaction conditions. Nevertheless, if the reaction conditions are properly controlled, a very narrow distribution of particle diameters can be obtained with an aerosol delivery system. As determined from examination of transmission electron micrographs, the primary particles generally have a distribution in sizes such that at least about 95 percent, and in further embodiments 99 percent, of the primary particles have a diameter greater than about 40 percent of the average diameter and less than about 225 percent of the average diameter. In some embodiments, the primary particles have a distribution of diameters such that at least about 95 percent, and in further embodiments 99 percent, of the primary particles have a diameter greater than about 45 percent of the average diameter and less than about 200 percent of the average diameter.

Furthermore, in some embodiments, effectively no primary particles have an average diameter greater than about 5 times the average diameter and in some embodiments 4 times the average diameter, and in further embodiments 3 times the average diameter. In other words, the particle size distribution effectively does not have a tail indicative of a small number of particles with significantly larger sizes. This is a result of the short residence time of the reactants in the reaction region and uniformity of the energy along the reaction zone. An effective cut off in the tail of the size distribution indicates that there are less than about 1 particle in 106 have a diameter greater than a specified cut off value above the average diameter. Narrow size distributions and lack of a tail in the distributions can be exploited in a variety of applications.

In addition, the nanoparticles generally have a very high purity level. The nanoparticles produced by the above described methods are expected to have a purity greater than the reactants because the laser pyrolysis reaction and, when applicable, the crystal formation process tends to exclude contaminants from the particle. Furthermore, crystalline submicron particles produced by laser pyrolysis can have a relatively high degree of crystallinity. Similarly, the crystalline nanoparticles produced by heat processing have a high degree of crystallinity. Certain impurities on the surface of the particles may be removed by heating the particles to achieve not only high crystalline purity but high purity overall.

In general, the phosphor particles can be selected metal/metalloid compositions often with a dopant to introduce desired electronic properties. The inorganic particles can be characterized as comprising a composition including a number of different elements and present in varying relative proportions, where the number and the relative proportions can be selected as a function of the application for the particles. Suitable numbers of different elements include, for example, numbers in the range(s) from about 2 elements to about 15 elements, with numbers of 1, 2, 3, 4, 5, 6, 7, 8, 9, 10, 11, 12, 13, 14, and 15 being contemplated. In some embodiments, some or all of the elements can be a metal/metalloid element. General numbers of relative proportions include, for example, values in the range(s) from about 1 to about 1,000,000, with numbers of about 1, 10, 100, 1000, 10000, 100000, 1000000, and suitable sums thereof being contemplated.

Alternatively or additionally, such submicron/nanoscale particles can be characterized as having the following formula:

AₐB_{b}C_{c}D_{d}EₑF_{f}G_{g}HₕIᵢJⱼKₖLₗMₘNₙOₒ,

where each A, B, C, D, E, F, G, H, I, J, K, L, M, N, and O is independently present or absent and at least one of A, B, C, D, E, F, G, H, I, J, K, L, M, N, and O is present and is independently selected from the group consisting of elements of the periodic table of elements comprising Group 1A elements, Group 2A elements, Group 3B elements (including the lanthanide family of elements and the actinide family of elements), Group 4B elements, Group 5B elements, Group 6B elements, Group 7B elements, Group 8B elements, Group 1 B elements, Group 2B elements, Group 3A elements, Group 4A elements, Group 5A elements, Group 6A elements, and Group 7A elements; and each a, b, C, d, e, f, g, h, i, j, k, l, m, n, and o is independently selected and stoichiometrically feasible from a value in the range(s) from about 1 to about 1,000,000, with numbers of about 1, 10, 100, 1000, 10000, 100000, 1000000, and suitable sums thereof being contemplated. The materials can be crystalline, amorphous or combinations thereof, although phosphors of particular interest are crystalline. In other words, the elements can be any element from the periodic table other than the noble gases. In general, all inorganic compositions are contemplated that can perform as phosphors, as well as all subsets of inorganic compounds as distinct inventive groupings, such as all inorganic compounds or combinations thereof except for any particular composition, group of compositions, genus, subgenus, alone or together and the like.

While some compositions are described with respect to particular stoichiometries/compositions, stoichiometries generally are only approximate quantities. In particular, materials can have contaminants, defects and the like. Furthermore, for amorphous and crystalline materials in which elements of a corresponding compound has a plurality of oxidation states, the materials can comprise a plurality of oxidation states. Thus, when stoichiometries are described herein, the actual materials may comprise minor amounts of other stoichiometries of the same elements also, such as SiO₂ also include some SiO and the like.

In embodiments of particular interest, the phosphor particles are crystalline inorganic compositions with a selected dopant. For example, certain metal/metalloid oxides or metal/metalloid sulfides with selected dopants can be used successfully as phosphors. In some embodiments, a rare earth metal element is a dopant that substitutes for a non-rare earth metal/metalloid and/or for another rare earth metal. The dopant can alter the light output and color of the material. Suitable red phosphors include, for example, YVO₄:Eu, ZnS:Mn, YBO₃:Eu, GdBO₃:Eu, Y₂O₃:Eu, and Y₃Al₅O₁₂:Eu. Suitable green phosphors include, for example, ZnS:Tb, Zn₂SiO₄:Mn, Y₃Al₅O₁₂:Tm, BaAl₁₂O₁₉:Mn and BaMgAl₁₄O₂₃:Mn. Suitable blue phosphors include, for example, ZnS:Ag, SrS:Ce, BaMgAl₁₄O₂₃:Eu, BaMgAl₁₀O₁₇:Eu, and Y₃Al₅O₁₂:Tb. In this notation, the doping element indicated on the right of the colon substitutes in the crystal lattice for one or more of the other metals in the oxide. The rare earth metal generally is in the form of an ion with a charge from +2 to +4.

The dopant generally comprises less than about 15 mole percent of the metal in the composition, in further embodiments less than about 10 mole percent, in some embodiments less than about 5 mole percent, in other embodiments from about 0.05 to about 1 mole percent of the metal/metalloid in the composition. A person of ordinary skill in the art will recognize that the present disclosure similarly covers ranges within these specific ranges.

YAG:Ce is currently the most used yellow phosphor in phosphor converted white light emitting diodes (WLED), although attempts are being made to develop other improved phosphors based on new compositions. However, the use of nanoscale YAG phosphors provide an alternative route to improve the performance of convention YAG. Examples of the production of nano-TAG:Ce are described below based on laser pyrolysis with post heat treatment.

With respect to the high performance phosphor particles of particular interest, the crystallinity, structural and composition purity, dopant level, dopant distribution in the particles, dopant location in the structure and dopant oxidation state can be significant properties for obtaining desired luminescent levels. The absorption of the particles generally is a function of the dopant concentration. Since the luminescence is a function of the absorption, the luminescence depends on the dopant concentration. However, the dopant levels cannot be increased to arbitrarily large values since excessive dopant can result in concentration quenching. At high enough dopant concentrations, quenching dominates and the total internal luminescence drops again. Thus, internal luminescence peaks as a function of dopant concentration. But the luminescence behavior has other parameters also. If the dopant has the correct oxidation state and occupies appropriate sites within the lattice, the position of the peak of the concentration curve can shift to higher concentrations. Since the particle crystallinity and dopant location in the lattice can be process dependent, the position of the peak can also depend on the processing conditions.

While the particles processed as described herein generally can be highly crystalline, subtle increases in the crystallinity and desirable dopant positioning can be significant with respect to desired performance properties. In particular, for submicron particles it can be difficult to obtain the degree of crystallinity to obtain desired performance properties. Thus, the heat treatment of the particles and subsequent processing can be controlled to improve these properties when the starting materials are laser pyrolysis produced particles that have high intrinsic crystallinity.

The degree of crystallinity can be evaluated from an x-ray diffractogram. For a particular crystalline structure, the location of the diffractogram peaks can be determined from bulk, i.e., larger than micron average particle size, powders. Based on the known peak positions, the area for the diffractogram of a sample under the known peaks can be measured. Then, the ratio of the measured peak areas divided by the total diffractogram area times 100 yields the percent crystallinity. This is a standard process in the art. For nanoscale particles, the x-ray diffractogram has broadened peaks based on known phenomena relating to the finite particle size and the x-ray interference. For materials with a high degree of crystallinity and a nano-scale, the accurate measurement of the degree of crystallinity can be difficult due to difficulty of measuring the peak areas accurately. However, accurate measurements can be made up to 90% crystallinity, and above 90% crystallinity measurements generally can be obtained at least as accurate as one percent. In some embodiments, the degree of crystallinity is at least about 90%, in other embodiments at least about 93 percent, in further embodiments, at least about 95 percent, and in other embodiments at least about 97 percent. A person of ordinary skill in the art will recognize that additional ranges of crystallinity within the explicit ranges above are contemplated and are within the present disclosure.

Also, it has been found that through heating aerosol precursors prior to performing laser pyrolysis, that higher dopant concentrations can be loaded into yttrium aluminum garnet (YAG) particles while shifting the concentration quenching to higher concentrations to yield a higher intrinsic luminescence. Through the ability to place additional dopant into the host crystalline material without increasing the quenching, the total luminescence of the material can be increased. The total luminosity is an important parameter for the production of associated products. If the luminosity is increased, the total amount of phosphor can be correspondingly decreased. Then, thinner structures and/or lower loadings can be used. The use of thinner structures and/or lower loadings further decrease the absorption loss and scattering loss further increasing the efficiency of the resulting device.

Furthermore, for the YAG phosphor particles, co-doping with La and Gd alters emission properties of YAG:Ce phosphor. With increase of the amount of co-doped elements, the emission maximum shifts toward the red light. So, YAG:Ce phosphor emits over a broad band with the maximum at 534 nm, with low doping at 1 atomic percent Ce. Co-doping with 10 atomic % La shifts the maximum to 558 nm. Co-doping with 15 atomic % Gd shifts the maximum to 548 nm.

### Dispersion and Surface Modification

To incorporate the phosphor powders into actual devices, generally the particles, i.e., powders, need to be placed in a form consistent with the structure within the device. Generally, such processing involves the dispersion of the particles and for some embodiments the incorporation of the particles into a composite, such as a polymer. In some embodiments, the dispersed phosphor particles can be used to form a coating. The use of a surface modifying agent can significantly improve the dispersion of the particles for the formation of materials for incorporation into composites or for other processing approach for devices. With the phosphor powders described herein, the particles can be very well dispersed to reduce the scattering and absorption of light in the resulting materials to produce a higher effective luminescence of the resulting structures. Thus, smaller structures with reduced total amounts of material can be effectively used to produce cheaper and better products.

The formation of a particle dispersion provides for the separation of the particles such that the particles can be well dispersed. The solvent, pH, ionic strength and additives can be selected to improve the dispersion of the particles. A good dispersion can be helpful for the delivery of the phosphor particles into a structure as well as for the formation of a blend with a polymer. The use of a dispersion can result in a more uniform blend with the particles approximately uniformly distributed through the blend. Greater dispersion of the particles and stability of the dispersions helps to reduce agglomeration of the particles in the resulting blend.

In some embodiments, the formation of a particle dispersion can be a distinct step of the process. For example, a collection of particles, e.g., nanoparticles, can be well dispersed for uniform introduction into a polymer blend. A liquid phase particle dispersion can provide a source of small secondary particles that can be used in the formation of desirable structures. Desirable qualities of a liquid dispersion of inorganic particles generally depend on the concentration of particles, the composition of the dispersion and the formation of the dispersion. Specifically, the degree of dispersion intrinsically depends on the inter-particle interactions, the interactions of the particles with the liquid and the surface chemistry of the particles. Suitable dispersants include, for example, water, organic solvents, such as alcohols and hydrocarbons, and combinations thereof. The selection of appropriate dispersants/solvents generally depends on the properties of the particles. The degree of dispersion and stability of the dispersion can be significant features for the production of uniform composites without large effects from significantly agglomerated particles.

Generally, the liquid dispersions refer to dispersions having particle concentrations of no more than about 80 weight percent. For the formation of a particle dispersion, the particular particle concentration depends on the selected application. At concentrations greater than about 50 weight percent, different factors can be significant with respect to the formation and characterization of the resulting viscous blend relative to parameters that characterize the more dilute particle dispersions. The concentration of particles affects the viscosity and can affect the efficacy of the dispersion process. In particular, high particle concentrations can increase the viscosity and make it more difficult to disperse the particles to achieve small secondary particle sizes, although the application of shear can assist with particle dispersion.

Since many polymers are soluble in organic solvents, some embodiments involve the formation of non-aqueous dispersions. In addition, water based dispersions can include additional compositions, such as buffers and salts. For particular particles, the properties of the dispersion can be adjusted by varying the pH and/or the ionic strength. Ionic strength can be varied by addition of inert salts, such as sodium chloride, potassium chloride or the like. The presence of the linker can affect the properties and stability of the dispersion. The pH generally affects the surface charge of the dispersed particles. The liquid may apply physical/chemical forces in the form of solvation-type interactions to the particles that may assist in the dispersion of the particles. Solvation-type interactions can be energetic and/or entropic in nature.

It can be useful to mill the powder prior to forming the dispersion. However, the milling should not be excessive since excessive milling can decrease the crystallinity of the powders. The milling can be performed in a bead mill or the like. Suitable mills are commercially available. In some embodiments, milling can be performed in the presence of a liquid. In some embodiments, it is desirable to mill the particles at low shear and low energy to avoid damaging the crystalline structure of the particles, which can result in significant decreases in luminescence of the particles.

The qualities of the dispersion generally depend on the process for the formation of the dispersion. In dispersions, besides chemical/physical forces applied by the dispersant and other compounds in the dispersion, mechanical forces can be used to separate the primary particles, which are held together by van der Waals forces and other short range electromagnetic forces between adjacent particles. In particular, the intensity and duration of mechanical forces applied to the dispersion significantly influences the properties of the dispersion. Alternatively, mechanical forces, such as shear stress, can be applied as mixing, agitation, jet stream collision and/or sonication following the combination of a powder or powders and a liquid or liquids. While in some embodiments, smaller secondary particles sizes can be obtained in some embodiments if there is more disruption of the agglomerating forces between the primary particles, excessive milling can damage the particles such that their performance as a phosphor can be reduced. Thus, there may be countervailing properties in selecting appropriate milling parameters.

The presence of small secondary particle sizes, e.g., close to the primary particle size, can result in significant advantages in the application of the dispersions for the formation of blends with uniform properties. For example, smaller secondary particle sizes, and generally small primary particle sizes, may assist with the formation of smoother and/or smaller and more uniform structures using the blends. In the formation of coatings, thinner and smoother coatings can be formed with blends formed with inorganic particle dispersions having smaller secondary particles. However, the optical properties of the resulting material also can be significantly improved due to better dispersion since the dispersed, more uniform particles generally have less scattering and less re-absorption of emitted light.

As noted above, any particle agglomerates can be dispersed in a dispersant to a significant degree based on the primary particles, and in some embodiments essentially completely to form dispersed primary particles. The size of the dispersed particles can be referred to as the secondary particle size. The primary particle size, of course, is the lower limit of the secondary particle size for a particular collection of particles, so that the average secondary particle size can be approximately the average primary particle size. The secondary or agglomerated particle size may depend on the subsequent processing of the particles following their initial formation and the composition and structure of the particles. In some embodiments, the average secondary particle size is no more than about a factor of five times the average primary particle size, in further embodiments no more than a factor of three times, and in additional embodiments from about a factor of 1.2 to a factor of 2.5 times the average primary particle size. In some embodiments, the secondary particles have an average diameter no more than about 1000 nm, in additional embodiments no more than about 500 nm, in further embodiments from about 2 nm to about 300 nm, in other embodiments about 2 nm to about 100 nm, and alternatively about 2 nm to about 50 nm. A person of ordinary skill in the art will recognize that other ranges of relative particle size and average particle size within these specific ranges are contemplated and are within the present disclosure. Secondary particles sizes within a liquid dispersion can be measured by established approaches, such as dynamic light scattering. Suitable particle size analyzers include, for example, a Microtrac UPA instrument from Honeywell based on dynamic light scattering, a Horiba Particle Size Analyzer from Horiba, Japan and ZetaSizer Series of instruments from Malvern based on Photon Correlation Spectroscopy. The principles of dynamic light scattering for particle size measurements in liquids are well established.

Once the dispersion is formed, the dispersion may eventually separate such that the particles collect on the bottom of the container without continued mechanical stirring or agitation. Stable dispersions have particles that do not separate out of the dispersion. Different dispersions have different degrees of stability. The stability of a dispersion depends on the properties of the particles, the other compositions in the dispersion, the processing used to form the dispersion and the presence of stabilizing agents. Suitable stabilizing agents include, for example, surface modifiers. Also, more stable dispersions generally allow for the formation of more concentrated dispersions that can be effectively used for further processing. In some embodiments, dispersions are reasonably stable, such that the dispersions can be used without significant separation during the subsequent processing steps forming structures and/or polymer the blends, although suitable processing to form a blend can be used involving constant mixing or the like to prevent separation of the particle dispersion.

Surface modifiers are generally non-polymeric molecules that have surface tension or bonding properties that encourage the compositions to spread over the particle surfaces and interact with the surface. These molecules can facilitate further processing through the formation of stable coated particles with predictable processing attributes provided by the surface modifier. The surface modifier may or may not bond with the particle surface. Classes of surface modifiers include, for example, compounds that bond to the surface and surface active agents. Suitable surface active agents include, for example, anionic surfactants, cationic surfactants, zwitter-ionic surfactants and non-ionic surfactants.

Suitable surface modifiers that bond to the particle surface depend on the chemical composition of the particles as well as possibly their surface chemistry. In general, suitable compounds for bonding to metal/metalloid oxide particles include, for example, carboxylic acids and alkoxyorganosilanes. The carboxylic acid molecules undergo an esterification-type reaction with the particle surface while the alkoxyorganosilanes react to form a bridging oxygen atom with the particle surface with the displacement of alkoxy group. Generally, thiol groups can be used to bind to metal sulfide particles and certain metal particles, such as gold, silver, cadmium and zinc. Carboxyl groups can bind to other metal particles, such as aluminum, titanium, zirconium, lanthanum and actinium. Similarly, amines and hydroxide groups would be expected to bond with metal oxide particles and metal nitride particles, as well as to transition metal atoms, such as iron, cobalt, palladium and platinum.

If the surface modifiers have a functional group that does not bind to the inorganic particle, the surface modifier can be used to bond to another coating composition applied with and/or over the surface modifier. For example, the surface modifier can bond to a polymer or monomer units applied to the surface to form a polymer network or crosslinked polymer. Processes to form bonded inorganic particle-polymer composites as bulk composites are described further in U.S. Pat. No. 6,599,631 to Kambe et al., entitled “Polymer-Inorganic Particle Composites,” incorporated herein by reference.

Dispersions of the phosphor particles can be directly coated onto a substrate to form a coating following drying to remove the solvent. The substrate can be selected based on the particular application. The coating can be performed with any suitable coating approach for the particular application, such as dip coating, spin coating, spray coating and the like. The solvent can be removed through evaporation with or without heating and/or vacuum.

In addition, the particles with a surface modifier can be dried to form a powder with a surface modifier. The surface modifier can pacify the surface and keep the particles separated. In some embodiments, the surface modified powder can be directly applied as a coating onto a selected substrate, in which gas can be used, if desired, to fluidize the powder during its application. Spray coating or the like can be used. Subsequent processing can be used to stabilize the coating on the surface.

### Polymer-Phosphor Particle Blends

Phosphor particle-polymer blends can be effectively used in a range of products. Since the blends can be formed at high loading levels with the phosphor particles described herein, these blends can provide for improved processing into the products. Similarly, using highly dispersable particles with high luminescence provides for the formation of thinner phosphor structures or structures with less total material without reducing the performance of the products. The particles may or may not be bonded with the polymers, and similarly the polymers may or may not be bonded with a surface modifier composition associated with the particles. The polymer can be selected to yield desired properties for the blend. Furthermore, in some embodiments, polymer-inorganic particle composites can comprise a plurality of different polymers and/or a plurality of different inorganic particles.

For formation of the composites, suitable organic polymers include, for example, polyamides (nylons), polyimides, polycarbonates, polyurethanes, polyacrylonitrile, polyacrylic acid, polyacrylates, polyacrylamides, polyvinyl alcohol, polyvinyl chloride, heterocyclic polymers, polyesters, modified polyolefins and copolymers and mixtures thereof. Composites formed with nylon polymers, i.e., polyamides, and inorganic nanoparticles can be called Nanonylon™. Suitable polymers include conjugated polymers within the polymer backbone, such as polyacetylene, and aromatic polymers within the polymer backbone, such as poly(p-phenylene), poly(phenylene vinylene), polyaniline, polythiophene, poly(phenylene sulfide), polypyrrole and copolymers and derivatives thereof. Suitable silicon-based polymers include, for example, polysilanes, polysiloxane (silicone) polymers, such as poly(dimethylsiloxane) (PDMS) and copolymers and mixtures thereof as well as copolymers and mixtures with organic polymers. To form covalent structures bonded to inorganic particles and/or surface modifying compositions, the polysiloxanes can be modified with amino and/or carboxylic acid groups. Polysiloxanes are desirable polymers because of their transparency to visible and ultraviolet light, high thermal stability, resistance to oxidative degradation and its hydrophobicity. Other inorganic polymers include, for example, phosphazene polymers (phosphonitrile polymers).

In some embodiments, the composite is formed into localized structures by self-assembly. The composition and/or structure of the composite can be selected to encourage self-organization of the composite itself. For example, block copolymers can be used such that the different blocks of the polymer segregate, which is a standard property of many block copolymers. Suitable block copolymers include, for example, polystyrene-block-poly(methyl methacrylate), polystyrene-block-polyacrylamide, polysiloxane-block-polyacrylate and mixtures thereof. In some embodiments, these block copolymers can be modified to include appropriate functional groups to bond directly or indirectly with the inorganic particles. For example, polyacrylates can be hydrolyzed or partly hydrolyzed to form carboxylic acid groups, or acrylic acid moieties can be substituted for all or part of the acrylated during polymer formation if the acid groups do not interfere with the polymerization. Alternatively, the ester groups in the acrylates can be substituted with ester bonds to diols or amide bonds with diamines such that one of the functional groups remains for bonding directly or indirectly with the inorganic particles. Block copolymers with other numbers of blocks and other types of polymer compositions can be used.

The inorganic particles can be associated with only one of the polymer compositions within the block such that the inorganic particles are segregated together with that polymer composition within the segregation block copolymer. For example, an AB di-block copolymer can comprise inorganic particles only within block A. Segregation of the inorganic particles can have functional advantages with respect to taking advantage of the properties of the inorganic particles. Similarly, tethered inorganic particles may separate relative to the polymer by analogy to different blocks of a block copolymer if the inorganic particles and the corresponding polymers have different solvation properties. In addition, the nanoparticles themselves can segregate relative to the polymer to form a self-organized structure.

Other ordered copolymers include, for example, graft copolymers, comb copolymers, star-block copolymers, dendrimers, mixtures thereof and the like. Ordered copolymers of all types can be considered a polymer blend in which the polymer constituents are chemically bonded to each other. Physical polymer blends may also be used and may also exhibit self-organization. Polymer blends involve mixtures of chemically distinct polymers. The inorganic particles may interact and/or bond to only a subset of the polymer species, as described above for block copolymers. Physical polymer blends can exhibit self-organization similar to block copolymers. The presence of the inorganic particles can sufficiently modify the properties of the composite that the interaction of the polymer with inorganic particles interacts physically with the other polymer species differently than the native polymer alone. In particular, the presence of nanoparticles within the polymer-inorganic particle blends can result in a blend that is sensitive to weak fields due to the small particle size. This sensitivity can be advantageously used in the formation of devices. Processes making use of small particles generally can be referred to as a soft matter approach.

Suitable composites can involve either low particle loadings or high particle loadings depending on the particular application. Similarly, the composition of the polymer component and the inorganic particle components can be selected to achieve desired properties of the resulting composite. The composites may represent a synergistic effect of the combined component with respect to relevant properties.

The inorganic particles can be incorporated at a range of loadings into the composite. Composites with low particle loadings can be produced with high uniformity. Low loadings, such as one or two percent or less, can be desirable for some applications. In addition, high inorganic particle loadings can be achieved with well-dispersed particles. In addition, high inorganic particle loadings of up to about 80 weight percent or greater can be achieved with well dispersed particles. In general, the inorganic particle loadings are from about 0.1 weight percent to about 90 weight percent, in other embodiments from about 1 weight percent to about 85 weight percent, in further embodiments from about 3 weight percent to about 80 weight percent, in additional embodiments from about 5 weight percent to about 65 weight percent and in some embodiments from about 10 to about 50 weight percent. A person of skill in the art will recognize that other ranges within these explicit ranges are contemplated and are within the present disclosure.

In some embodiments, polymer inorganic-particle composites comprise chemical bonding between the inorganic particles and the polymer to form a bonded composite. In other embodiments, the composites comprise mixtures or blends of inorganic particles and polymers. The composition of the components of the composites and the relative amounts of the components can be selected to yield desired properties, such as optical properties. Similarly, a surface modifier composition can bond to the polymer, and the surface modifier composition may or may not be bonded to the inorganic particle. If the surface modifier is bonded to both the inorganic particle and the polymer, it is referred to as a linker. In corresponding embodiments, the amount the linker compounds bonded to the inorganic particles can be adjusted to vary the degree of crosslinking obtained with the polymer.

Various structures can be formed based on the fundamental idea of forming the chemically bonded polymer/inorganic particle composites. The structures obtained will generally depend on the relative amounts of polymer/monomers, linkers and inorganic particles as well as the synthesis process itself. Linkers may be identified also as coupling agents or crosslinkers. If a poly-inorganic particle composite comprises a plurality of different polymers and/or a plurality of different inorganic particles, all of the polymer and/or inorganic particles can be chemically bonded within the composite or, alternatively, only a fraction of the polymers and inorganic particles can be chemically bonded within the composite. If only a fraction of the polymer and/or inorganic particles are chemically bonded, the fraction bonded can be a random portion or a specific fraction of the total polymer and/or inorganic particles.

The linker compounds have two or more functional groups. One functional group of the linker is suitable for chemical bonding to the inorganic particles. Chemical bonding is considered to broadly cover bonding with some covalent character with or without polar bonding and can have properties of ligand-metal bonding along with various degrees of ionic bonding. The functional group can be selected based on the composition of the inorganic particle. Another functional group of the linker is suitable for covalent bonding with the polymer. Covalent bonding refers broadly to covalent bonds with sigma bonds, pi bonds, other delocalized covalent bonds and/or other covalent bonding types, and may be polarized bonds with or without ionic bonding components and the like. Convenient linkers include, for example, functionalized organic molecules.

In some embodiments, the linker is applied to form at least a significant fraction of a monolayer on the surface of the particles. In particular, for example, at least about 20% of a monolayer can be applied to the particles, and in other embodiments, at least about 40% of a monolayer can be applied. Based on the measured BET surface areas of the particles, a quantity of linker can be used corresponding up to coverage about ½, 1 and 2 of the particle surface relative to a monolayer of the linker. A person of ordinary skill in the art will recognize that other ranges within these explicit ranges are contemplated and are within the present disclosure. A monolayer is calculated based on measured surface area of the particles and an estimate of the molecular radius of the linker based on accepted values of the atomic radii. Excess linker reagent can be added because not all of the linker binds and some self-polymerization of the linker reagent may take place in some embodiments. To calculate the coverage, the linker can be assumed to bond to the particle normal to the surface. This calculation provides an estimate of the coverage. It has been found experimentally that higher coverage could be placed over the surface of the particles than estimated from these calculations. With these high linker coverages, the linkers presumably form a highly crosslinked structure with the polymers. At each inorganic particle, multi-branched crosslinking structures are formed.

The inorganic particles can be bonded through the linker compound into the polymer structure, or the particles can be grafted to polymer side groups. The bonded inorganic particles can, in most embodiments, crosslink the polymer. Specifically, most embodiments involve star crosslinking of a single inorganic particle with several polymer groups. The structure of the composite can generally be controlled by the density of linkers, the length of the linkers, the chemical reactivity of the coupling reaction, the density of the reactive groups on the polymer as well as the loading of particles and the molecular weight range of the polymer (i.e., monomer/polymer units). In alternative embodiments, the polymer has functional groups that bond directly with the inorganic particles, either at terminal sites or at side groups. In these alternative embodiments, the polymer includes functional groups comparable to appropriate linker functional groups for bonding to the inorganic particles.

For the formation of polymer composites with a linker, during formation or after formation of the particle dispersion, the dispersion is interacted with the linker molecules and/or the polymer. To form the desired composites, the inorganic particles may be modified on their surface by chemical bonding to one or more linker molecules. Generally, for embodiments involving a linker, the linker is soluble in the liquid used to form the inorganic particle dispersion and/or the polymer dispersion so that the linker is substantially homogeneously dissolved when bonding from solution. Conditions for the combined particle dispersion and polymer dispersion/solution can be suitable for the formation of bonds between the linker, the inorganic particles and the polymer. The order for adding the linker to the inorganic particles and the polymer can be selected to achieve the desired processing effectiveness. Once sufficient time has passed to complete the bonding between the components of the composite material, the composite can be processed further into the desired product.

The ratio of linker composition to inorganic particles preferably is at least one linker molecular per inorganic particle. The linker molecules surface modify the inorganic particles, i.e., functionalize the inorganic particles. While the linker molecules bond to the inorganic particles, they are not necessarily bonded to the inorganic particles prior to bonding to the polymers. They can be bonded first to the polymers and only then bonded to the particles. Alternatively, the components can be blended such that bonding between the linker and the two species occurs roughly simultaneously.

The linker compound and the polymer/monomer components can be added to the liquid with the particle dispersion simultaneously or sequentially. The order of combining the various constituents can be selected to achieve the desired results. The conditions within the liquid preferably are suitable for the bond formation with the linker and possibly other bond formation involving the polymer/monomer constituents. Once the composite is formed, the liquid can be removed or solidified to leave behind a structure formed from the composite.

The polymer/monomer composition can be formed into a solution/dispersion prior to addition to the inorganic particle dispersion, or the polymer/monomer can be added as a solid to the particle dispersion. In some embodiments, the polymer/monomer compositions are soluble in the liquid used to form the particle dispersion. If the polymer/monomer is not soluble/dispersible in the particle dispersion, either the polymer/monomer solution or the particle dispersion is slowly added to the other while mixing to effect the reaction. Whether or not the polymer/monomer is first solubilized separate from the inorganic particle dispersion may depend on the kinetics of the polymer/monomer solubilization and on the desired concentrations of the various solutions/dispersions. Similarly, bonding kinetics can influence the order and details of the mixing procedures.

In some embodiments, the reaction conditions and/or the presence of a catalyst or the like is needed to initiate the reaction of the linker with the inorganic particle and/or the polymer/monomer. In these embodiments, the components can be mixed prior to the adjustment of the reaction conditions of the addition of a catalyst. Thus, a well mixed solution/dispersion can be formed prior to the adjustment of the reaction conditions or addition of the catalyst to form a more uniform composite.

To form bonded composites, many different types of polymers are suitable as long as they have terminal groups and/or preferably side groups capable of bonding to a linker. Some polymers can be bonded to linkers at functional side groups. The polymer can inherently comprise desired functional groups, can be chemically modified to introduce desired functional groups or copolymerized with monomer units to introduce portions of desired functional groups. Similarly, some composites comprise only a single polymer/monomer composition bonded into the composite. Within a crosslinked structure, a polymer is identifiable by 3 or more repeat units along a chain, except for hydrocarbon chains which are not considered polymers unless they have a repeating side group or at least about 50 carbons—carbon bonds within the chain.

Appropriate functional groups for binding with the polymer depend on the functionality of the polymer. Generally, the functional groups of the polymers and the linker can be selected appropriately based on known bonding properties. For example, carboxylic acid groups bond covalently to thiols, amines (primary amines and secondary amines) and alcohol groups. As a particular example, nylons can comprise unreacted carboxylic acid groups, amine groups or derivatives thereof that are suitable form covalently bonding to linkers. In addition, for bonding to acrylic polymers, a portion of the polymer can be formed from acrylic acid or derivatives thereof such that the carboxylic acid of the acrylic acid can bond with amines (primary amines and secondary amines), alcohols or thiols of a linker. The functional groups of the linker can provide selective linkage either to only particles with particular compositions and/or polymers with particular functional groups. Other suitable functional groups for the linker include, for example, halogens, silyl groups (—SiR₃₋ₓ,Hₓ), isocyanate, cyanate, thiocyanate, epoxy, vinyl silyls, silyl hydrides, silyl halogens, mono-, di- and trihaloorganosilane, phosphonates, organometalic carboxylates, vinyl groups, allyl groups and generally any unsaturated carbon groups (—R′—C═C—R″), where R′ and R″ are any groups that bond within this structure. Selective linkage can be useful in forming composite structures that exhibit self-organization.

Upon reaction of the polymer functional groups with the linker functional groups, the identity of initial functional groups is merged into a resultant or product functional group in the bonded structure. A linkage is formed that extends from the polymer. The linkage extending from the polymer can include, for example, an organic moiety, a siloxy moiety, a sulfide moiety, a sulphonate moiety, a phosphonate moiety, an amine moiety, a carbonyl moiety, a hydroxyl moiety, or a combination thereof. The identity of the original functional groups may or may not be apparent depending on the resulting functional group. The resulting functional groups generally can be, for example, an ester group, an amide group, an acid anhydride group, an ether group, a sulfide group, a disulfide group, an alkoxy group, a hydrocarbyl group, a urethane group, an amine group, an organo silane group, a hydridosilane group, a silane group, an oxysilane group, a phosphonate group, a sulphonate group or a combination thereof.

If a linker compound is used, one resulting functional group generally is formed where the polymer bonds to the linker and a second resulting functional group is formed where the linker bonds to the inorganic particle. At the inorganic particle, the identification of the functional group may depend on whether particular atoms are associated with the particle or with the functional group. This is just a nomenclature issue, and a person of skill in the art can identify the resulting structures without concern about the particular allocation of atoms to the functional group. For example, the bonding of a carboxylic acid with an inorganic particle may result in a group involving bonding with a non-metal/metalloid atom of the particle; however, an oxo group is generally present in the resulting functional group regardless of the composition of the particle. Ultimately, a bond extends to a metal/metalloid atom.

Appropriate functional groups for bonding to the inorganic particles depends on the character of the inorganic particles. U.S. Pat. No. 5,494,949 to Kinkel et al., entitled “SURFACE-MODIFIED OXIDE PARTICLES AND THEIR USE AS FILLERS AND MODIFYING AGENTS IN POLYMER MATERIALS,” incorporated herein by reference, describes the use of silylating agents for bonding to metal/metalloid oxide particles. The particles have alkoxy modified silane for bonding to the particles. For example, preferred linkers for bonding to metal/metalloid oxide particles include R¹R²R³—S¹—R⁴, where R¹, R², R³ are alkoxy groups, which can hydrolyze and bond with the particles, and R⁴ is a group suitable for bonding to the polymer. Trichlorosilicate (—SiCl₃) functional groups can react with an hydroxyl group at the metal oxide particle surface by way of a condensation reaction.

Generally, thiol groups can be used to bind to metal sulfide particles and certain metal particles, such as gold, silver, cadmium and zinc. Carboxyl groups can bind to other metal particles, such as aluminum, titanium, zirconium, lanthanum and actinium. Similarly, amines and hydroxide groups would be expected to bind with metal oxide particles and metal nitride particles, as well as to transition metal atoms, such as iron, cobalt, palladium and platinum.

The identity of the linker functional group that bonds with the inorganic particle may also be modified due to the character of the bonding with the inorganic particle. One or more atoms of the inorganic particle are involved in forming the bond between the linker and the inorganic particle. It may be ambiguous if an atom in the resulting linkage originates from the linker compound or the inorganic particle. In any case, a resulting or product functional group is formed joining the linker molecule and the inorganic particle. The resulting functional group can be, for example, one of the functional groups described above resulting from the bonding of the linker to the polymer. The functional group at the inorganic particle ultimately bonds to one or more metal/metalloid atoms.

In some embodiments, the polymer incorporates the inorganic particles into the polymer network. This can be performed by reacting a functional group of the linker compound with terminal groups of a polymer molecule. Alternatively, the inorganic particles can be present during the polymerization process such that the functionalized inorganic particles are directly incorporated into the polymer structure as it is formed. In other embodiments, the inorganic particles are grafted onto the polymer by reacting the linker functional groups with functional groups on polymer side groups. In any of these embodiments, the surface modified/functionalized inorganic particles can crosslink the polymer if there are sufficient linker molecules, i.e., enough to overcome energetic barriers and form at least two or more bonded links to the polymer. Generally, an inorganic particle can have many linkers associated with the particle. Thus, in practice, the crosslinking depends on the polymer-particle arrangement, statistical interaction of two crosslinking groups combined with molecular dynamics and chemical kinetics.

### Phosphor Applications

A variety of desirable phosphor particles and their preparation are described in detail herein. The phosphors emit light, such as visible light, following excitation. Some useful phosphors emit light in the infrared portion of the light spectrum. A variety of ways can be used to excite the phosphors, and particular phosphors may be responsive to one or more of the excitation approaches. Particular types of luminescence include, for example, cathodoluminescence, photoluminescence and electroluminescence which, respectively, involve excitation by electrons, light and electric fields. Many materials that are suitable as chathodo-luminescence phosphors are also suitable as electroluminescence phosphors.

In particular, the phosphor particles can be suitable for low-velocity electron excitation, with electrons accelerated with potentials below 1 kilovolts (KV), and more preferably below 100 V. The small size of the particles makes them suitable for low velocity electron excitation. Low energy electron excitation can be used because the correspondingly lower penetration distances of the electrons are less limiting as the particle size decreases.

Furthermore, nanoscale particles can produce high luminescence, for example, with low electron velocity excitation. As the voltages decrease, high luminosity can be expected from small sized particles, although a particle size may be reached beyond which even smaller particle sizes can result in slightly reduced luminosity. The effects of decreasing particle size on phosphors is described theoretically in “The Effects of Particle Size And Surface Recombination Rate on the Brightness of Low-Energy Phosphor,” J. S. Yoo et al., J. App. Phys. 81 (6), 2810-2813 (Mar. 15, 1997), incorporated herein by reference.

Improved phosphor particles can be effectively used in a range of visualization applications. For example, the phosphor particles can be used in displays, vehicle lighting, public lighting, signage and other general lighting. Similarly, the phosphors can be used for x-ray scintillation.

The phosphor particles can be used to produce any of a variety of display devices. In some displays, the phosphors are self emitting, for example, as a result of electroluminescence or cathodoluminescence. In some displays, the phosphors effectively produce desired visualization as a results of back lighting, for example, with excitation from a liquid crystal backlight or light emitting diode backlight. These displays can be used in home electronics or in vehicle displays. More general lighting applications include, for example, traffic lights, street lights, signage and home lighting.

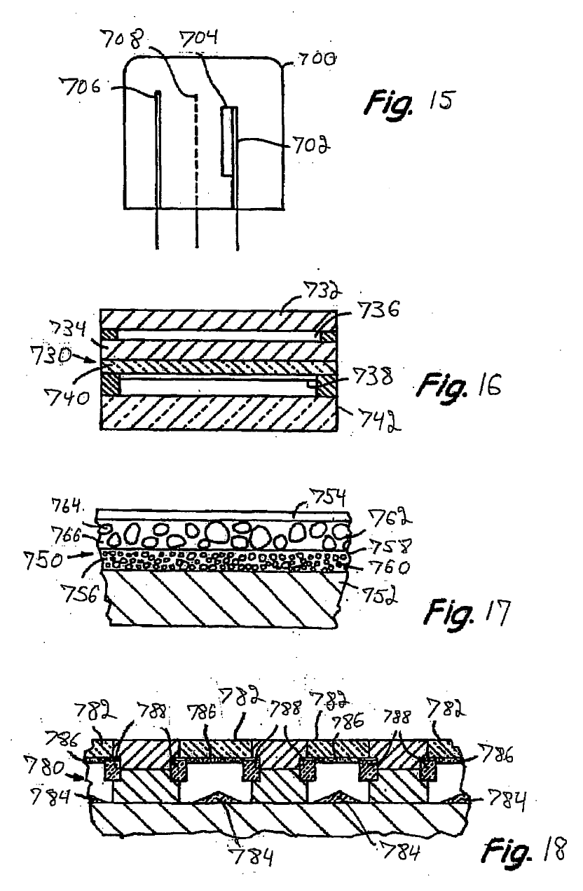

In one representative embodiment, referring to FIG. 15, a display device 700 comprises an anode 702 with a phosphor layer 704 on one side. The phosphor layer faces an appropriately shaped cathode 706, which is the source of electrons used to excite the phosphor. A grid cathode 708 can be placed between the anode 702 and the cathode 706 to control the flow of electrons from the cathode 706 to the anode 702.

Cathode ray tubes (CRTs) have been used for a long time for producing images. CRTs generally use relatively higher electron velocities. Phosphor particles, as described above, can still be used advantageously as a convenient way of supplying particles of different colors, reducing the phosphor layer thickness and decreasing the quantity of phosphor for a given luminosity. CRTs have the general structure as shown in FIG. 15, except that the anode and cathode are separated by a relatively larger distance and steering electrodes rather than a grid electrode generally are used to guide the electrons from the cathode to the anode. The use of phosphors in CRTs is described further, for example, in U.S. Pat. No. 5,523,114 to Tong et al., entitled “Surface Coating With Enhanced Color Contrast for Video Display,” incorporated herein by reference.

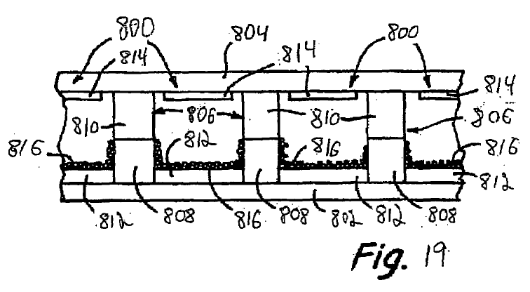

Other suitable applications include, for example, the production of flat panel displays. Flat panel displays can be based on, for example, liquid crystals or field emission devices. Liquid crystal displays can be based on any of a variety of light sources. Phosphors can be useful in the production of lighting for liquid crystal displays. Referring to FIG. 16, a liquid crystal element 730 includes at least partially light transparent substrates 732, 734 surrounding a liquid crystal layer 736. Lighting is provided by a phosphor layer 738 on an anode 740. Cathode 742 provides a source of electrons to excite the phosphor layer 738. Alternative embodiments are described, for example, in U.S. Pat. No. 5,504,599, entitled “Liquid Crystal Display Device Having An EL Light. Source In A Non-Display Region or a Region Besides A Display Picture Element,” incorporated herein by reference.

Liquid crystal displays can also be illuminated with backlighting from an electroluminescent display. Referring to FIG. 17, electroluminescent display 750 has a conductive substrate 752 that functions as a first electrode. Conductive substrate 752 can be made from, for example, aluminum, graphite or the like. A second electrode 754 is transparent and can be formed from, for example, indium tin oxide. A dielectric layer 756 may be located between electrodes 752, 754, adjacent to first electrode 752. Dielectric layer 756 includes a dielectric binder 758 such as cyanoethyl cellulose or cyanoethyl starch. Dielectric layer 756 can also include ferroelectric material 760 such as barium titanate. Dielectric layer 756 may not be needed for dc-driven (in contrast with α-driven) electro-luminescent devices. A phosphor layer 762 is located between transparent electrode 754 and dielectric layer 762. Phosphor layer 762 includes electroluminescent particles 764 in a dielectric binder 766. Backlight LCD displays are described further, for example, in U.S. Patent Application 2004/0056990 to Setlur et al., entitled “Phosphor Blends and Backlight Sources For Liquid Crystal Displays,” incorporated herein by reference.

Electroluminescent display 750 also can be used for other display applications such as automotive dashboard and control switch illumination. In addition, a combined liquid crystal/electroluminescent display has been designed. See, Fuh, et al., Japan J. Applied Phys. 33:L870-L872 (1994), incorporated herein by reference.

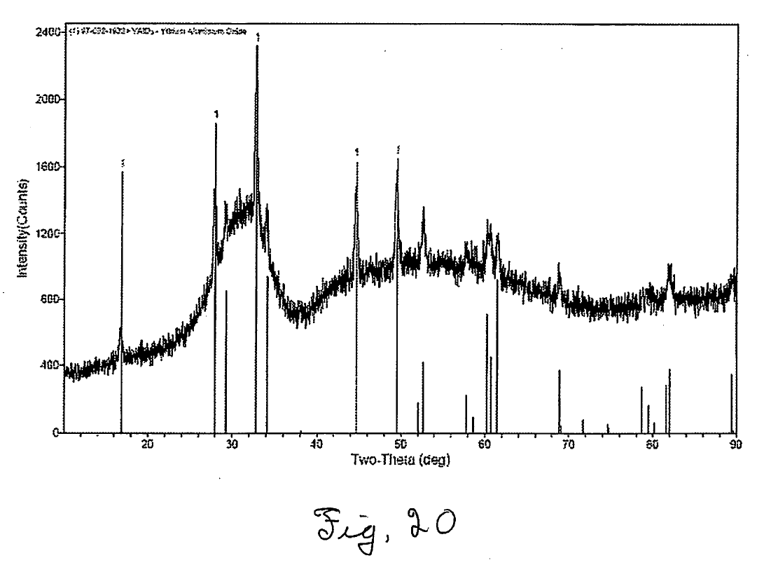

Referring to FIG. 18, a display 780 based on field emission devices involves anodes 782 and cathodes 784 spaced a relatively small distance apart. Each electrode pair forms an individually addressable pixel. A phosphor layer 786 is located between each anode 782 and cathode 784. The phosphor layer 786 includes phosphorescent nanoparticles as described above. Phosphorescent particles with a selected emission frequency can be located at a particular addressable location. The phosphor layer 786 is excited by low velocity electrons traveling from the cathode 784 to the anode 782. Grid electrodes 788 can be used to accelerate and focus the electron beam as well as act as an on/off switch for electrons directed at the phosphor layer 786. An electrically insulating layer is located between anodes 782 and grid electrodes 788. The elements are generally produced by photolithography and/or other suitable techniques such as sputtering and chemical vapor deposition for the production of integrated circuits. As shown in FIG. 18, the anode should be at least partially transparent to permit transmission of light emitted by phosphor 786.

Alternatively, U.S. Pat. No. 5,651,712, entitled “Multi-Chromic Lateral Field Emission Devices With Associated Displays And Methods Of Fabrication,” incorporated herein by reference, discloses a display incorporating field emission devices having a phosphor layer oriented with an edge (rather than a face) along the desired direction for light propagation. The construction displayed in this patent incorporates color filters to produce a desired color emission rather than using phosphors that emit at desired frequencies. Based on the particles described above, selected phosphor particles can be used to produce the different colors of light, thereby eliminating the need for color filters.

Phosphors are also used in plasma display panels for high definition televisions and projection televisions. These applications require high luminescence. However, standard phosphors generally result in low conversion efficiency. Thus, there is significant heat to dissipate and large energy waste. Use of submicron or nanoscale particles can increase the luminescence and improve the conversion efficiency. Submicron/nanoscale particle based phosphors with high surface area can effectively absorb ultraviolet light and convert the energy to light output of a desired color.

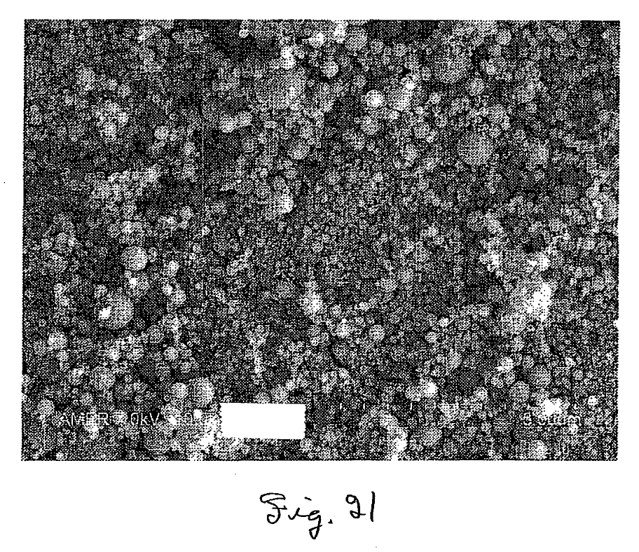

An embodiment of several elements 800 of a plasma display panel in a cut away sectional view is shown in FIG. 19. A plasma display panel comprises a two dimensional array of plasma display elements 800 that are independently addressable. Elements 800 are located between two glass plates 802, 804 spaced apart by distance on the order of 200 microns. At least glass plate 802 is transparent. Barrier walls 806 separation glass plates 802, 804. Barrier walls 806 include an electrically conducting portion 808 and an electrically insulating section 810.

Each plasma display element 800 includes a cathode 812 and a transparent anode 814 formed from a metal mesh or indium tin oxide. A phosphor coating 816 is placed over the surface of the cathode. A noble gas, such as neon, argon, xenon or mixtures thereof, is placed between the electrodes in each element. When the voltage is sufficiently high, plasma forms and emits ultraviolet light. Plasma display panels that incorporate phosphor particles are described further in U.S. Pat. No. 6,833,672 to Aoki et al., entitled “Plasma Display Panel and a Method for Producing a Plasma Display Panel,” incorporated herein by reference.

The composite materials with a phosphor described herein can be used as an encapsulant for a light emitting diode. As used herein, a light emitting diode (LED) includes diode lasers as well as incoherent light emitting diodes. The composites with a phosphor can shift the wavelength of emitted light. A representative configuration of an LED encapsulant is shown in U.S. Pat. No. 6,921,929 to LeBoeuf et al., entitled “Light-Emitting Diode (LED) With Amorphous Fluoropolymer Encapsulant and Lens,” incorporated herein by reference. White light emitting phosphor blends for light emitting diode (LED) devices are described further, for example, in U.S. Pat. No. 6,621,211 to Srivastava et al., entitled “White Light. Emitting Phosphor Blends for LED Devices,” incorporated herein by reference. In addition, phosphors that are used in surface electron displays (SED) are described further, for example, in U.S. Pat. No. 6,015,324 to Potter, entitled “Fabrication Process for Surface Electron Display Device With Electron Sink,” incorporated herein by reference.

Similarly, the phosphors can be incorporated into fluorescent lighting. For example, these lights can be used for traffic lights, street lighting, home lighting and the like. Also, improved phosphors with suitable compositions can be used in x-ray scintillation counters, as described further in U.S. Pat. No. 6,974,955 to Okada et al., entitled “Radiation Detection Device and System, and Scintillator Panel Provided to the Same,” incorporated herein by reference.

The phosphor particles can be adapted for use in a variety of other devices beyond the representative embodiments specifically described. The highly crystalline submicron/nanoscale particles described herein can be directly applied to a substrate to produce the above structures. Alternatively, in some embodiments, the phosphor particles can be mixed with a polymer binder such as a curable polymer for application to a substrate. A composition involving a curable binder and the phosphor particles can be applied to a substrate by photolithography, screen printing or other suitable technique for patterning a substrate such as used in the formation of integrated circuit boards. Once the composition is deposited at a suitable positions on the substrate, the material can be exposed to suitable conditions to cure the polymer. The polymer can be curable by electron beam radiation, UV radiation or other suitable techniques.

### EXAMPLES

### Example 1—Laser Pyrolysis Synthesis of Doped Yttrium Aluminum Oxide

This example demonstrates the synthesis of doped yttrium aluminum oxide with a perovskite crystal structure by laser pyrolysis with an aerosol. Laser pyrolysis was carried out using a reaction chamber essentially as described above with respect to FIGS. 3A, 4 and 5. The chamber is designed to add additional inert gas to the flow following particle formation to cool the particles. The gas pressure at the aerosol atomizer was generally 17 psi with a synthesis pressure in the reaction chamber of 200 Torr.

Yttrium (III) nitrate hexahydrate (99.9% pure), Aluminum nitrate nonahydrate (98% pure or 99.997% pure), and cerium (III) nitrate hexahydrate (99% or 99.99% pure) precursors were dissolved in deionized water. The precursors were obtained from Alfa Aesar, Inc., Ward Hill, Mass. The solution was stirred on a hot plate using a magnetic stirrer. The aqueous metal precursor solutions were carried into the reaction chamber as an aerosol. C₂H₄ gas was used as a laser absorbing gas, and nitrogen was used as an inert diluent gas. The reactant mixture containing the metal precursors, N₂, O₂ and C₂H₄ was introduced into the reactant nozzle for injection into the reaction chamber. Additional parameters of the laser pyrolysis synthesis relating to the particles of Example 1 are specified in Table 1. With respect to results reported in subsequent examples, additional samples were run with the conditions of column 1 in Table 1 with differing cerium dopant amounts.

TABLE 1

| | 1 | 2 | 3 |
|---|---|---|---|
| Yttrium Concentration (M) | 0.148 | 0.148 | 0.148 |
| Aluminum Concentration (M) | 0.25 | 0.25 | 0.25 |
| Cerium Concentration (M) | 0.002 | 0.002 | 0.002 |
| Pressure (Torr) | 200 | 200 | 200 |
| Nitrogen F.R.-Window (SLM) | 4 | 4 | 4 |
| Argon F.R.-Shielding (SLM) | 2 | 2 | 2 |
| Ethylene (SLM) | 1.8 | 2 | 2.7 |
| Diluent Gas (Nitrogen) (SLM) | 22 | 21.5 | 16 |
| Oxygen (SLM) | 5.4 | 5.4 | 5.4 |
| Laser Input (Watts) | 1800 | 1800 | 1800 |
| Laser Output (Watts) | 1460 | 1460 | 1540 |
| Production Rate (g/hr) | 0.6 | 1 | 0.5 |
| Precursor Delivery Rate to | 8 | 8 | 8 |
| Atomizer* (ml/min) | | | |

To evaluate the atomic arrangement, the samples were examined by x-ray diffraction using the Cr(Kα) radiation line on a Rigaku Miniflex x-ray diffractometer. In each of the samples, crystalline phases were identified that corresponded to yttrium aluminum perovskite (YAP) and yttrium aluminum monoclinic (YAM) by comparison with known diffractograms. A representative x-ray diffractogram is shown in FIG. 20.

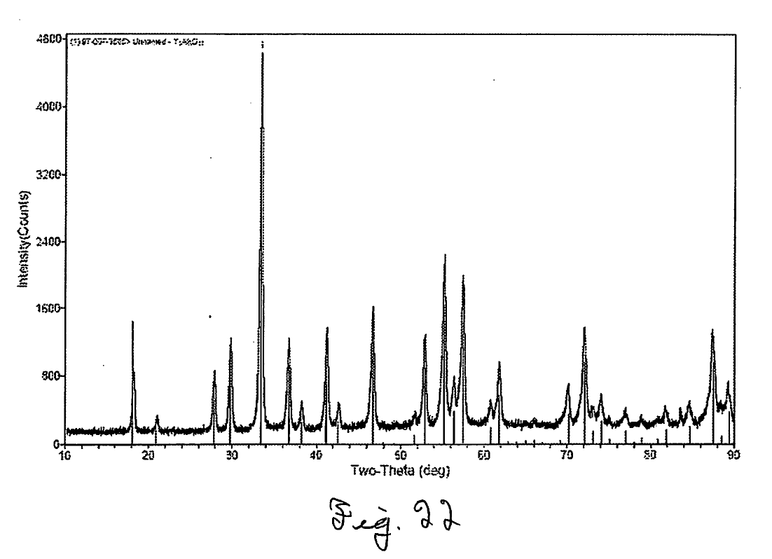

Scanning electron micrographs were taken of these samples. These micrographs show a bimodal distribution of particle sizes with a majority of small nanoparticles with diameters from 10 nm to 100 nm and a fraction of larger particles with sizes from 200 nm to 1000 nm. A representative scanning electron micrograph is shown in FIG. 21. Optimization of aerosol production is expected to be successful in eliminating the portion of the distribution with the larger particles.

### Example 2—Heat Treatment to Form Yttrium Aluminum Garnet (YAG)

This example demonstrates the conversion of the yttrium aluminum oxide particles to the garnet phase, i.e., yttrium aluminum garnet (YAG).

Samples of cerium doped yttrium aluminum oxide nanoparticles produced by laser pyrolysis according to the conditions specified in column 1 of Table 1 were heated in an oven with one, two or three heating steps. At least some of these steps were performed under reducing conditions. The oven was essentially as described above with respect to FIG. 14. Between about 100 and about 700 mg of nanoparticles were placed in an open 1 cc alumina boat within an alumina tube projecting through the oven. Gas was flowed through the oven through a 3.0 inch diameter quartz tube at a flow rate of about 100 sccm.

The heating conditions for the one step, two step and three step heat process are summarized in Tables 2, 3 and 4, respectively.

TABLE 2
Heat treatment condition for one step heat processing

| | Sequence |
|---|---|
| | 1^{st} |
| Temperature (° C.) | 1400 |
| Time (hour) | 2 |
| Environment | Air |

TABLE 3
Heat treatment condition for two step heat processing

Sequence

| | 1^{st} | 2^{nd} |
|---|---|---|
| Temperature (° C.) | 550 | 950 |
| Time (hour) | 1 | 60 |
| Environment | Air | Ar + 2% H2 |

TABLE 4
Heat treatment condition for three step heat processing

| | Sequence | | |
|---|---|---|---|
| | 1^{st} | 2^{nd} | 3^{rd} |
| Temperature (° C.) | 550 | 1200 | 700 |
| Time (hour) | 1 | 2 | 12 |
| Environment | Air | Ar + 2% H2 | Ar + 2% H2 |

Referring to Tables 3 and 4, a low temperature heating step can be performed with air present to oxidize any carbon associated with the phosphor particles. Due to the low temperatures of 550° C., the cerium is not oxidized significantly under these conditions. The higher temperature heating steps in Tables 3 and 4 are performed with a mixture of 98 atomic percent Argon and 2 mole percent H₂ to produce a slightly reducing atmosphere. A relatively lower temperature with an extended dwell time in the second heating stage is possible for the three-step heat treatment in Table 4 to significantly reduce sintering. For example, the second heating step can be performed for six hours at 1000° C. rather than two hours at 1200° C.

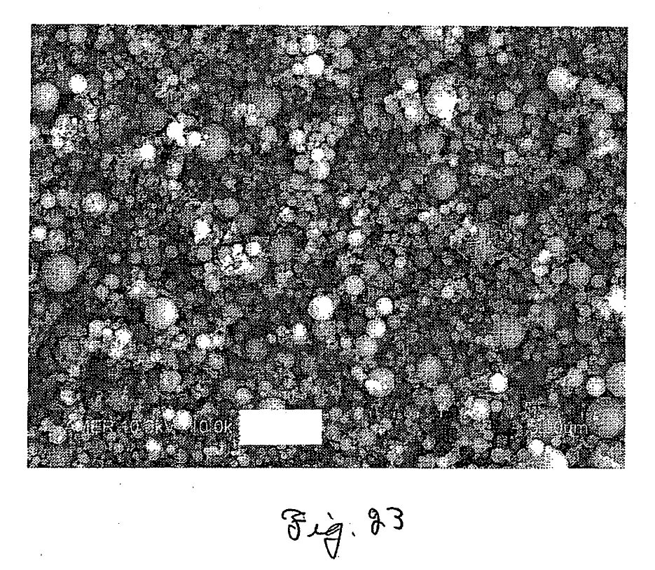

The crystal structure of the resulting heat treated particles was determined by x-ray diffraction. The x-ray diffractograms are similar to each other and correspond to highly crystalline, phase pure samples of cerium doped YAG. A representative x-ray diffractogram is shown in FIG. 22 for a sample after a three step heating process.

Scanning electron microscopy (SEM) was used to evaluate particle sizes and morphology of the heat treated samples. A representative SEM micrograph is shown in FIG. 23 for a sample subjected to a three step heating process.

The ratios of Ce⁺³ to Ce⁺⁴ was determined for the heat treated samples using x-ray photoelectron spectroscopy (XPS). The two cerium ions have different binding energies in the x-ray spectrum. For one representative sample, the heat treatment changed the ratio Ce⁺⁴/Ce⁺³ from 2.31 to 1.96. Thus, there is a significant improvement in the amount of Ce⁺³ present if the heating conditions are controlled as described above. A commercial sample from YAG-KO was also examined. It had a Ce⁺⁴/Ce⁺³ ratio of 2.22, which is very similar to the as synthesize value from laser pyrolysis.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

What is claimed is:

1. A collection of particles comprising a crystalline phosphor composition, the collection of particles having a number average primary particle size of no more than about 100 nm, a weight average secondary particle size of no more than about 250 nm and an crystallinity of at least about 90%.

2. The collection of particles of claim 1 wherein the number average primary particle size is no more than about 50 nm.

3. The collection of particles of claim 1 wherein the weight average secondary particle size is from about 50 nm to about 150 nm.

4. The collection of particles of claim 1 wherein effectively no primary particles have a diameter greater than about 5 times the average primary particle diameter.

5. The collection of particles of claim 1 wherein the primary particles have a diameter distribution such that at least about 95 percent of the particles have a diameter greater than about 40 percent of the average diameter and less than about 225 percent of the average diameter.

6. The collection of particles of claim 1 wherein the crystalline phosphor composition comprises a host lattice and a dopant from about 0.1 mole percent to about 20 mole percent.

7. The collection of particles of claim 6 wherein the dopant comprises a rare earth metal.

8. The collection of particles of claim 6 wherein the host lattice comprises a metal oxide or a metalloid oxide.

9. The collection of particles of claim 6 wherein the host lattice comprises yttrium aluminum garnet.

10. The collection of particles of claim 1 further comprising a surface modifier chemically bonded to the surface of the particle.

11. A liquid dispersion comprising the collection of particles of claim 1.

12. A composition comprising a monomer or a polymer, and the collection of particles of claim 1.

13. A method for the production of particles in a flowing reactor, the method comprises reacting a reactant flow to generate product particles within the flow in which the reactant flow comprises a heated aerosol wherein the heated aerosol is heated to a temperature at least about 10° C. greater than ambient temperature.

14. The method of claim 13 wherein the reaction is driven by a light beam that intersects the reactant flow, which comprises compositions that absorb light from the beam.

15. The method of claim 13 wherein the product particles have an average particle size of no more than about 500 nm.

16. A method for processing a collection of inorganic phosphor particles having an average particle size no more than about 250 nm, the method comprising heating the particle collection at a first temperature from about 250° C. to about 600° C. for 5 minutes to about five hours in an oxidizing atmosphere and a heating the particle collection in a reducing atmosphere for about 5 minutes to about 48 hours at a second temperature above the first temperature and sufficient to anneal the crystal structure of the particles while being at least above the transformation onset temperature of a desired phase and at least 100° C. below the melting temperature of the particles.

17. The method of claim 16 further comprising heating the particle collection at a third temperature below the third temperature and above the first temperature for five hours to 24 hours in a reducing atmosphere without causing significant sintering of the particles while increasing the crystallinity of the particles as determined by x-ray scattering.
